(19) United States
(12) Patent Application Publication
(10) Pub. No.: US 2020/0313991 A1
(43) Pub. Date: Oct. 1, 2020

(54) SERVICE RECEIVING OR TRANSMITTING METHOD AND DEVICE, AND COMMUNICATION SYSTEM

(71) Applicant: FUJITSU LIMITED, Kawasaki-shi (JP)

(72) Inventors: Guorong LI, Beijing (CN); Meiyi JIA, Beijing (CN); Lei ZHANG, Beijing (CN); Xin WANG, Beijing (CN)

(73) Assignee: FUJITSU LIMITED, Kawasaki-shi (JP)

(21) Appl. No.: 16/899,775

(22) Filed: Jun. 12, 2020

Related U.S. Application Data
(63) Continuation of application No. PCT/CN2018/076738, filed on Feb. 13, 2018.

(51) Int. Cl. H04L 12/26

(52) U.S. Cl. CPC H04L 43/0852; H04L 43/067; H04L 43/0817; H04L 43/0888

(57) ABSTRACT

A service reception or transmission method and apparatus and a communication system. The service reception or transmission apparatus includes: a processing unit configured to perform reception or transmission of a low-latency service within a measurement gap when a time duration for performing reception or transmission of the low-latency service is overlapped with the measurement gap. Hence, when a configured measurement gap occurs in process of performing reception or transmission of a low-latency service, latency of the low-latency service may be reduced, and user experiences of low-latency service may be ensured.

### CROSS REFERENCE TO RELATED APPLICATIONS

This application is a continuation application of International Application No. PCT/CN2018/076738, filed on Feb. 13, 2018, the contents of which are incorporated herein by reference.

### TECHNICAL FIELD

This disclosure relates to the field of communication technologies, and in particular to a service receiving or transmitting method and device and a communication system.

### BACKGROUND

As mentioned in the 3rd Generation Partnership Project (3GPP) standards, measurement is divided into intra-frequency measurement and inter-frequency measurement. The intra-frequency measurement refers to that a cell where a terminal equipment is currently located and a target to be measured are on the same carrier frequency point (a central frequency point). And the inter-frequency measurement refers to that a cell where a terminal equipment is currently located and a target to be measured are not on the same carrier frequency point.

When the terminal equipment needs to perform inter-frequency or inter-radio access technology (RAT) measurement, the network side may configure a measurement gap for the terminal equipment in advance, which indicates the time period that may be used by the terminal equipment to perform the measurement. During this period, the terminal equipment has not uplink and downlink transmission to be scheduled, but will be adjusted to a frequency point of the target cell to perform inter-frequency or inter-RAT measurement, and then returned to the current cell at the end of the measurement gap.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

Currently, various data applications and services based on mobile communication networks have grown rapidly, and terminals served by the mobile communication networks have also been expanded from traditional smart phone terminals with people as subjects to other types of terminals with machines as subjects. In order to be adapted to such a trend of change, future mobile communication networks need to be able to provide more flexible and diverse services to meet demands of different terminal equipment and different services.

For this reason, in a fifth generation (5G) mobile communication system, not only traditional enhanced mobile broadband (eMBB) services, but also massive machine type communications (mMTC) services and ultra-reliable and low-latency communications (URLLC) services, may be supported. Requirements of the URLLC services are very sensitive to latency. For example, a target of latency of a user plane is 0.5 ms for uplink and downlink, a reliability requirement on one time of transmission of a packet is that an error rate of 10⁻⁵ should be reached for 32 bytes, and at the same time, a requirement on latency is that user plane latency is 1 ms.

It was found by the inventors that currently a length of a measurement gap in low-frequency band is usually configured as 6 ms, 4 ms, or 3 ms, and a measurement gap period is 20 ms, 40 ms, 80 ms, or 160 ms; while a length of a measurement gap in a high-frequency band is usually configured as 5.5 ms, 3.5 ms, or 1.5 ms, a measurement gap period is 20 ms, 40 ms, 80 ms, or 160 ms. If a measurement gap occurs during reception or transmission of a URLLC service, according to provisions of existing standards, a terminal equipment is unable to perform reception or transmission of URLLC services during this measuring gap, which will result in increase of latency of the reception or transmission of URLLC services, and will be unable to meet requirements of URLLC services for latency indices.

In order to solve the foregoing problems, embodiments of the present disclosure provide a service reception or transmission method and apparatus and a communication system, in which when a configured measurement gap occurs in process of performing reception or transmission of a low-latency service, latency of the low-latency service may be reduced, and user experiences of low-latency service may be ensured.

According to a first aspect of the embodiments of this disclosure, there is provided a service reception or transmission method, including:

performing reception or transmission of a low-latency service by a terminal equipment within a measurement gap when a time duration for performing reception or transmission of the low-latency service is overlapped with the measurement gap.

According to a second aspect of the embodiments of this disclosure, there is provided a service reception or transmission method, including:

transmitting configuration information by a network device to a terminal equipment, the configuration information configuring that the terminal equipment performs reception or transmission of a low-latency service within a measurement gap when a time duration for performing the reception or transmission of the low-latency service by the terminal equipment is overlapped with the measurement gap, or when a time duration for performing the reception or transmission of the low-latency service by the terminal equipment is overlapped with the measurement gap and a predetermined condition related to a change of service quality is satisfied;

or the configuration information configuring that when the terminal equipment has a grant, the grant overrides a measurement gap for performing reception or transmission of a low-latency service;

or transmitting first indication information by a network device to a terminal equipment, the first indication information indicating information on a measurement gap for performing reception or transmission of a low-latency service.

According to a third aspect of the embodiments of this disclosure, there is provided a measurement method, including:

not performing measurement by a terminal equipment within a measurement gap or a part of time of a measurement gap when a time duration for performing reception or transmission of a low-latency service is overlapped with the measurement gap.

According to a fourth aspect of the embodiments of this disclosure, there is provided a measurement method, including:

transmitting configuration information by a network device to a terminal equipment, the configuration information configuring that the terminal equipment does not perform measurement within a measurement gap when a time duration for performing the reception or transmission of a low-latency service by the terminal equipment is overlapped with the measurement gap, or when a time duration for performing reception or transmission of a low-latency service by the terminal equipment is overlapped with the measurement gap and a predetermined condition related to a change of service quality is satisfied;

or the configuration information configuring that when the terminal equipment has a grant, the grant overrides a measurement gap for not performing measurement;

or transmitting first indication information by a network device to a terminal equipment, the first indication information indicating information on a measurement gap for not performing measurement.

According to a fifth aspect of the embodiments of this disclosure, there is provided a service reception or transmission apparatus, including:

a processing unit configured to perform reception or transmission of a low-latency service within a measurement gap when a time duration for performing reception or transmission of the low-latency service is overlapped with the measurement gap.

According to a sixth aspect of the embodiments of this disclosure, there is provided a service reception or transmission apparatus, including:

a first transmitting unit configured to transmit configuration information to a terminal equipment, the configuration information configuring that the terminal equipment performs reception or transmission of a low-latency service within a measurement gap when a time duration for performing the reception or transmission of the low-latency service by the terminal equipment is overlapped with the measurement gap, or when a time duration for performing the reception or transmission of the low-latency service by the terminal equipment is overlapped with the measurement gap and a predetermined condition related to a change of service quality is satisfied;

or the configuration information configuring that when the terminal equipment has a grant, the grant overrides a measurement gap for performing reception or transmission of a low-latency service;

or transmit first indication information to a terminal equipment, the first indication information indicating information on a measurement gap for performing reception or transmission of the low-latency service.

According to a seventh aspect of the embodiments of this disclosure, there is provided a measurement apparatus, including:

a processing unit configured to not perform measurement within a measurement gap or a part of time duration of a measurement gap when a time duration for performing reception or transmission of a low-latency service is overlapped with the measurement gap.

According to an eighth aspect of the embodiments of this disclosure, there is provided a measurement apparatus, including:

a transmitting unit configured to transmit configuration information to a terminal equipment, the configuration information configuring that the terminal equipment does not perform measurement within a measurement gap or a part of time duration of a measurement gap when a time duration for performing reception or transmission of a low-latency service by the terminal equipment is overlapped with the measurement gap, or when a time duration for performing reception or transmission of a low-latency service by the terminal equipment is overlapped with the measurement gap and a predetermined condition related to a change of service quality is satisfied;

or the configuration information configuring that when the terminal equipment has a grant, the grant overrides a measurement gap for not performing measurement;

or transmitting first indication information by a network device to a terminal equipment, the first indication information indicating information on a measurement gap for not performing measurement.

An advantage of the embodiments of this disclosure exists in that reception or transmission of a low-latency service is performed within a measurement gap when a time duration for performing the reception or transmission of the low-latency service is overlapped with the measurement gap. Hence, when a configured measurement gap occurs in process of performing reception or transmission of a low-latency service, latency of the low-latency service may be reduced, and user experiences of low-latency service may be ensured.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/includes” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of a communication system of an embodiment of this disclosure;

FIG. 2 is a flowchart of a service reception or transmission method of Embodiment 1 of this disclosure;

FIGS. 3A-3D are schematic diagrams of a time duration for performing reception or transmission of a low-latency service being overlapped with a measurement gap of Embodiment 1 of this disclosure;

FIG. 4 is a flowchart of an implementation of a service reception or transmission method of Embodiment 2 of this disclosure;

FIG. 5 is a schematic diagram of service reception or transmission of Embodiment 2 of this disclosure;

FIG. 6 is a flowchart of an implementation of a service reception or transmission method of Embodiment 2 of this disclosure;

FIG. 7 is a schematic diagram of service reception or transmission of Embodiment 2 of this disclosure;

FIG. 8 is a schematic diagram of arrival of an existing low-latency service within a measurement gap;

FIG. 9 is a flowchart of a service reception or transmission method of Embodiment 5 of this disclosure;

FIG. 10 is a flowchart of a service reception or transmission method of Embodiment 5 of this disclosure;

FIG. 11 is a flowchart of a service reception or transmission method of Embodiment 5 of this disclosure;

FIG. 12 is a flowchart of a service reception or transmission method of Embodiment 5 of this disclosure;

FIG. 13 is a flowchart of a measurement method of Embodiment 6 of this disclosure;

FIG. 14 is a flowchart of a measurement method of Embodiment 7 of this disclosure;

FIG. 15 is a flowchart of a measurement method of Embodiment 7 of this disclosure;

FIG. 16 is a flowchart of a measurement method of Embodiment 7 of this disclosure;

FIG. 17 is a flowchart of a measurement method of Embodiment 7 of this disclosure;

FIG. 18 is a schematic diagram of a service reception or transmission apparatus of Embodiment 8 of this disclosure;

FIG. 19 is a schematic diagram of a structure of a terminal equipment of Embodiment 9 of this disclosure;

FIG. 20 is a schematic diagram of a service reception or transmission apparatus of Embodiment 10 of this disclosure;

FIG. 21 is a schematic diagram of a structure of a network device of Embodiment 11 of this disclosure;

FIG. 22 is a schematic diagram of a measurement apparatus of Embodiment 12 of this disclosure;

FIG. 23 is a schematic diagram of a terminal equipment of Embodiment 13 of this disclosure;

FIG. 24 is a schematic diagram of a measurement apparatus of Embodiment 14 of this disclosure;

FIG. 25 is a schematic diagram of a network device of Embodiment 15 of this disclosure; and

FIGS. 26-28 are schematic diagrams of structures of three implementations of service reception or transmission apparatus of Embodiment 8 of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims. Various embodiments of this disclosure shall be described below with reference to the accompanying drawings, and these embodiments are illustrative only, and are not intended to limit this disclosure.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, and/or other communication protocols that are currently known or will be developed in the future.

In the embodiments of this disclosure, the term “network device”, for example, refers to an equipment in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC).

The base station may include but not limited to a node B (NodeB or NB), an evolved node B (eNodeB or eNB), and a 5G base station (gNB). Furthermore, it may include a remote radio head (RRH), a remote radio unit (RRU), a relay, or a low-power node (such as a femto, and a pico). The term “base station” may include some or all of its functions, and each base station may provide communication coverage for a specific geographical area. And a term “cell” may refer to a base station and/or its coverage area, which is dependent on a context of the term.

In the embodiments of this disclosure, the term “user equipment (UE)” or “terminal equipment (TE)” refers to, for example, equipment accessing to a communication network and receiving network services via a network device. The user equipment may be fixed or mobile, and may also be referred to as a mobile station (MS), a terminal, a subscriber station (SS), an access terminal (AT), or a station, etc.

The user equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal.

Scenarios in the embodiments of this disclosure shall be described below by way of examples; however, this disclosure is not limited thereto.

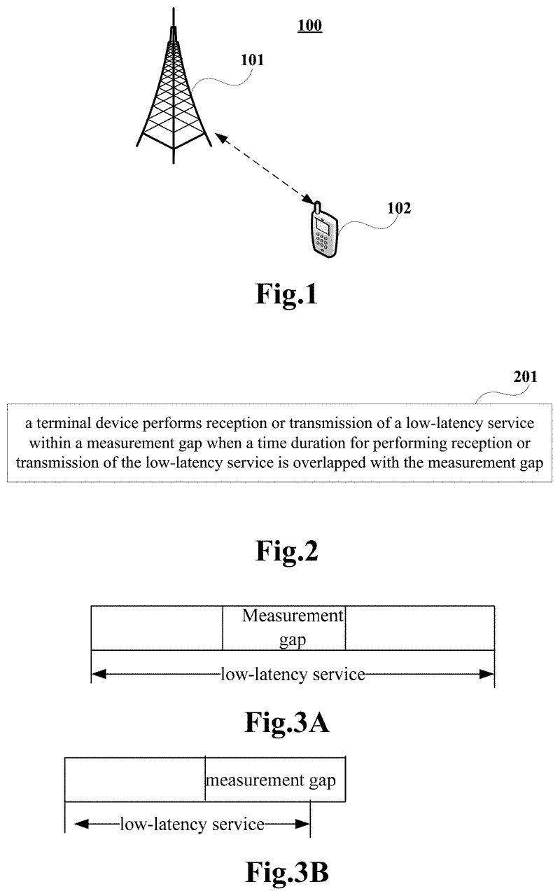

FIG. 1 is a schematic diagram of a communication system of an embodiment of this disclosure, in which a case where a user equipment and a network device are taken as examples is schematically shown. As shown in FIG. 1, a communication system 100 may include a network device 101 and a terminal equipment 102. For the sake of simplicity, description is given in FIG. 1 by taking one terminal equipment and one network device only as an example; however, the embodiments of this disclosure are not limited thereto.

In the embodiment of this disclosure, existing services or services that may be implemented in the future may be performed between the network device 101 and the terminal equipment 102. For example, such services may include but not limited to an enhanced mobile broadband (eMBB), massive machine type communication (MTC), and ultra-reliable and low-latency communication (URLLC). In this disclosure, the embodiments shall be described by taking a URLLC service sensitive to latency as an example; however, this disclosure is not limited thereto, and it is also applicable to other services sensitive to latency.

The embodiments of this disclosure shall be described below with reference to the accompanying drawings.

### Embodiment 1

Embodiment 1 of this disclosure provides a service reception or transmission method. FIG. 2 is a flowchart of the service reception or transmission method of this embodiment, which is applicable to a terminal equipment side. As shown in FIG. 2, the method includes:

step 201: a terminal equipment performs reception or transmission of a low-latency service within a measurement gap when a time duration for performing reception or transmission of the low-latency service is overlapped with the measurement gap.

It can be seen from the above embodiment that reception or transmission of the low-latency service is performed within the measurement gap. Hence, when a configured measurement gap occurs in the process of performing reception or transmission of a low-latency service, latency of the low-latency service may be reduced, and user experiences of low-latency service may be ensured.

In this embodiment, when the terminal equipment needs to perform inter-frequency measurement, the network side configures the terminal equipment with a measurement gap, including configuring a length of the measurement gap and a period of the measurement gap; wherein a length of a measurement gap for a low frequency band is usually configured as 6 ms, or 4 ms or 3 ms, and a measurement gap period is 20 ms, or 40 ms, or 80 ms, or 160 ms; while a length of a measurement gap for a high frequency band is usually configured as 5.5 ms, or 3.5 ms or 1.5 ms, and a measurement gap period is 20 ms, or 40 ms, or 80 ms, or 160 ms.

In this embodiment, the low-latency service refers to a service sensitive to latency, such as a service with a requirement on latency being less than or equal to a threshold D; where, the threshold D is usually less than or equal to the length of the measurement gap.

In this embodiment, at the terminal equipment side, the performing reception of a low-latency service indicates that the low-latency service is a downlink low-latency service, and the performing transmission of a low-latency service indicates that the low-latency service is an uplink low-latency service; wherein the performing reception of a low-latency service refers to monitoring a low-latency service, which may include actually receiving a low-latency service, may also include receiving no service, and may also include receiving a control channel related to a low-latency service; and the performing transmission of a low-latency service refers to transmitting an actual low-latency service and/or transmitting information related to a low-latency service; for example, the related information may be a service scheduling request (SR) transmitted to the network side before transmitting the actual low-latency service, notifying the network side that the terminal equipment needs to transmit a low-latency service, or the related information may be uplink acknowledgement (ACK) for a received downlink low-latency service or channel quality information.

In this embodiment, that a time duration for performing reception or transmission of the low-latency service is overlapped with the measurement gap may indicate that the time duration for performing reception or transmission of the low-latency service overrides the entire time duration period of the measurement gap, or it may indicate that the time duration for performing reception or transmission of the low-latency service overrides a part of time duration of the measurement gap, which is not limited in this embodiment.

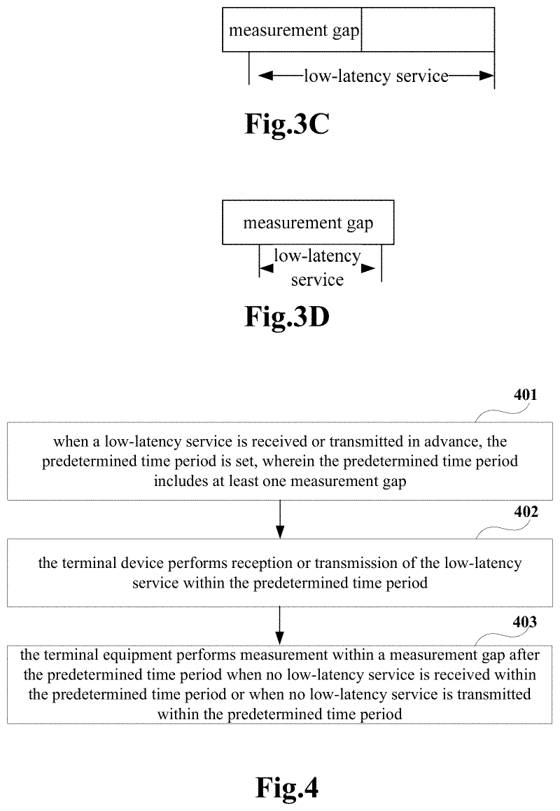

FIGS. 3A-3D are schematic diagrams of the time duration for performing reception or transmission of a low-latency service being overlapped with the measurement gap of this embodiment. As shown in FIG. 3A, the time duration for performing reception or transmission of a low-latency service overrides the entire time duration period of the measurement gap. As shown in FIG. 3B, the time duration for performing reception or transmission of a low-latency service overrides an earlier time duration period of the measurement gap. As shown in FIG. 3C, the time duration for performing reception or transmission of a low-latency service overrides a later time duration period of the measurement gap. As shown in FIG. 3D, the time duration for performing reception or transmission of a low-latency service overrides a middle time duration period of the measurement gap. All the above examples indicate that the time duration for performing reception or transmission of the low-latency service is overlapped with the measurement gap, and this embodiment is not limited thereto.

In this embodiment, when the time duration for performing reception or transmission of the low-latency service is overlapped with the measurement gap, the terminal equipment performs reception or transmission of the low-latency service within the measurement gap, and within the time period of performing reception or transmission of the low-latency service, the terminal equipment may not perform measurement, such as inter-frequency measurement, or inter-radio access technology (RAT) measurement; wherein reception or transmission of the low-latency service may be performed in the entire time period in the measurement gap, and no measurement is performed, or reception or transmission of the low-latency service may be performed in a part of the time period in the measurement gap (such as the part of the time period in the measurement gap overlapped with the time duration for performing reception or transmission of the low-latency service), and measurement is performed in the other part of the time period, that is, in the measurement gap, in performing reception or transmission of the low-latency service, no measurement is performed, and details shall be described later in embodiments 2-4.

In this embodiment, the low-latency service may arrive before a measurement gap starts (such as before a first measurement gap starts, or between adjacent measurement gaps, equivalent to before a later measurement gap starts), or may arrive within a measurement gap, or the low-latency service may be received or transmitted by configuring a grant, or may be received or transmitted in a dynamically scheduling manner (in which when the low-latency service will arrive is unable to be predicted). How to perform reception or transmission of the low-latency service in the above cases shall be respectively described below with reference to embodiment 2-4.

### Embodiment 2

Embodiment 2 of this disclosure provides a service reception or transmission method, applicable to a terminal equipment side. In this embodiment, on the basis of Embodiment 1, how to perform reception or transmission of the low-latency service when the low-latency service arrives before the measurement gap starts shall be further described.

In one implementation, the network device may predefine or preconfigure that when the time duration for performing reception or transmission of the low-latency service is overlapped with the measurement gap, the terminal equipment performs reception or transmission of the low-latency service within the measurement gap; and in a case where the low-latency service arrives before a measurement gap starts, when the time duration for performing reception or transmission of the low-latency service is overlapped with the measurement gap, the terminal equipment performs reception or transmission of the low-latency service within the measurement gap according to the predefinition or preconfiguration.

In this implementation, reception or transmission of the low-latency service is performed within a measurement gap, as long as the measurement gap is overlapped with the time duration for performing reception or transmission of the low-latency service, that is, the measurement gap is overridden by the time duration for performing reception or transmission of the low-latency service, and no inter-frequency measurement or inter-RAT measurement is performed.

In this implementation, the measurement gap may be contained in a set predetermined time duration period, and the terminal equipment performs reception or transmission of the low-latency service within the predetermined time period.

FIG. 4 is a flowchart of the implementation of the service reception or transmission method of this embodiment. As shown in FIG. 4, the method includes:

step 401: when a low-latency service is received or transmitted in advance, the predetermined time period is set, wherein the predetermined time period includes at least one measurement gap; and step 402: a terminal equipment performs reception or transmission of the low-latency service within the predetermined time period.

In step 401, the predetermined time period may be set by starting a timer. The timer may be started immediately after the low-latency service is received or transmitted in advance, or the timer may be started in a predetermined time period after the low-latency service is received or transmitted in advance, and this embodiment is not limited thereto. In addition, a length of the predetermined time period is not limited in this disclosure; for example, the predetermined time period may include at least one measurement gap. In step 402, reception or transmission of the low-latency service is performed by the terminal equipment within the predetermined time period, and reference may be made to Embodiment 1 for a particular meaning of the performing reception or transmission of the low-latency service, which shall not be described herein any further.

In this implementation, the method may further include:

step 403 (optional): the terminal equipment performs measurement within a measurement gap after the predetermined time period when no low-latency service is received within the predetermined time period or when no low-latency service is transmitted within the predetermined time period.

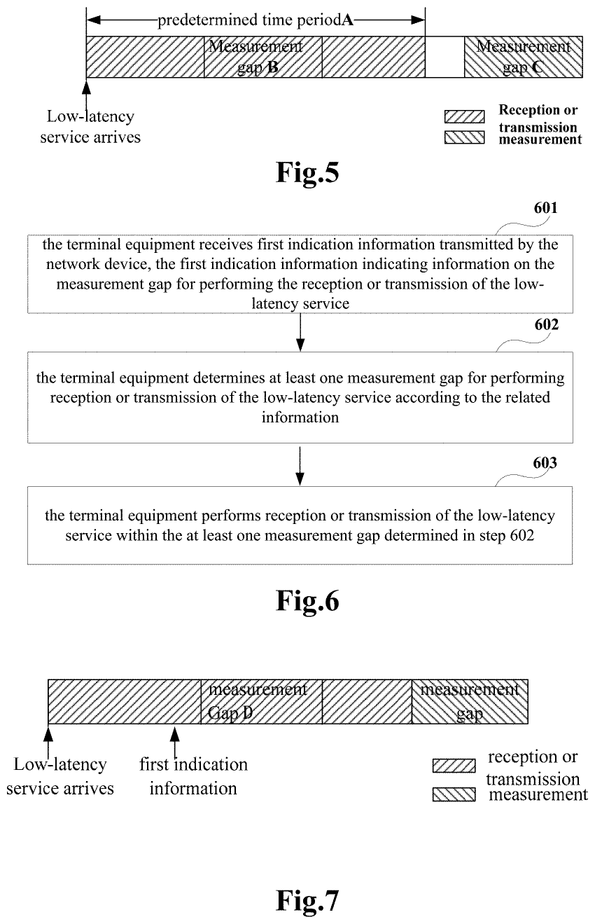

FIG. 5 is a schematic diagram of this implementation. As shown in FIG. 5, when the low-latency service is received or transmitted in advance, the predetermined time period A is set, which includes a measurement gap B, and the terminal equipment performs reception or transmission of the low-latency service within the predetermined time period A (including the measurement gap B), and performs measurement within a measurement gap C after the predetermined time period.

In this implementation, the method may further include (not shown): the terminal equipment receives configuration information transmitted by the network device, the configuration information configuring that a terminal equipment performs reception or transmission of a low-latency service within a measurement gap when a time duration for performing the reception or transmission of the low-latency service by the terminal equipment is overlapped with the measurement gap, the configuration information being to be described in Embodiment 5.

In one implementation, the network device may transmit first indication information to the terminal equipment, indicating information on a measurement gap for performing the reception or transmission of the low-latency service. In the case where the low-latency service arrives before the measurement gap starts, when the time duration for performing reception and transmission of the low-latency service is overlapped with the measurement gap, the terminal equipment determines to perform reception and transmission of the low-latency service within the measurement gap according to the first indication information.

In this implementation, reception and transmission of the low-latency service is performed in a measurement gap as long as the measurement gap is indicated in the first indication information, that is, the measurement gap is overidden by the time duration for performing reception and transmission of the low-latency service, and no inter-frequency measurement or inter-RAT measurement needs to be performed.

In this implementation, the information on the measurement gap includes information on a number and/or a position of the measurement gap for performing the reception or transmission of the low-latency service; where the information on position may be information on a starting time or a starting position or an ending time or an ending position of the measurement gap or information on a overridden time period of the measurement gap, and the terminal equipment may determine the measurement gap according to the information on a starting time or a starting position or an ending time or an ending position, and may determine a overridden measurement gap within the time period according to the overridden time period of the measurement gap.

In this implementation, the first indication information is carried by a downlink control channel (PDCCH), or medium access control (MAC) or radio resource control (RRC) signaling.

In this implementation, the first indication information may be transmitted before the low-latency service arrives, or may be transmitted after the low-latency service arrives, but it needs to be received before the overridden measurement gap.

FIG. 6 is a flowchart of the implementation of the service reception or transmission method. As shown in FIG. 6, the method includes:

step 601: the terminal equipment receives first indication information transmitted by the network device, the first indication information indicating information on the measurement gap for performing the reception or transmission of the low-latency service;

step 602: the terminal equipment determines at least one measurement gap for performing reception or transmission of the low-latency service according to the related information; and

step 603: the terminal equipment performs reception or transmission of the low-latency service within the at least one measurement gap determined in step 602; wherein reference may be made to Embodiment 1 for a particular meaning of the performing reception or transmission of the low-latency service, which shall not be described herein any further.

FIG. 7 is a schematic diagram of this implementation. As shown in FIG. 7, the first indication information, including information on a measurement gap D, is received, and the measurement gap D is determined by the terminal equipment according to the first indication information, and reception and transmission of the low-latency service is performed within the measurement gap D, without needing to perform inter-frequency measurement or inter-RAT measurement.

In this embodiment, if service quality of a serving cell where the terminal equipment is located is relatively poor, even if the reception and transmission of the low-latency service is performed within the measurement gap, the low-latency service may not be normally received or transmitted due to that the service quality is relatively poor. Hence, in this embodiment, when a predetermined condition related to a change of the service quality is satisfied, the reception and transmission of the low-latency service may be performed within the measurement gap (such as the measurement gap included in the predetermined time period, or the measurement gap indicated by the first indication information). Thus, the quality of the serving cell may be ensured, and a user experience of the low-latency service may be ensured.

Hence, in this embodiment, before performing the reception or transmission of the low-latency service, the method further includes (not shown): the terminal equipment determines that a predetermined condition related to a change of service quality is satisfied; and the terminal equipment performs the reception or transmission of the low-latency service within the measurement gap when the predetermined condition related to a change of service quality is satisfied.

In this embodiment, the predetermined condition includes that service quality of a serving cell is higher than a first threshold, or service quality of a serving cell is higher than a second threshold, and service quality of a neighboring cell is lower than a third threshold, or service quality of a neighboring cell is lower than a fourth threshold, or service quality of a serving cell is higher than service quality of a neighboring cell, or service quality of a serving cell is higher than service quality of a neighboring cell by a fifth threshold; wherein the above thresholds may be determined as demanded, and this embodiment is not limited thereto.

In this implementation, whether the above predetermined condition is satisfied may be determined according to whether existing triggering events A2, A3, A4, A5, B1 and B2 are triggered. For example, A2, A3, A4, A5, B1 and B2 being not triggered indicates that the service quality of the serving cell is higher than the second threshold and the service quality of the neighboring cell is lower than the third threshold, or the service quality of the neighboring cell is lower than the fourth threshold, or the service quality of the serving cell is higher than the service quality of the neighboring cell, or the service quality of the serving cell is higher than the service quality of the neighboring cell by the fifth threshold; wherein reference may be made to the related art for particular meanings of the triggering events A2, A3, A4, A5, B1 and B2, which shall not be described herein any further.

In this embodiment, the method further includes (not shown): second indication information transmitted by the network device is received, the second indication information indicating the predetermined condition. After receiving the second indication information, the terminal equipment determines the predetermined condition according to the second indication information, determines whether the predetermined condition is satisfied, and performs reception or transmission of the low-latency service within the measurement gap if the predetermined condition is satisfied.

In this embodiment, the method further includes (not shown): configuration information transmitted by the network device is received, the configuration information indicating that the terminal equipment performs reception or transmission of the low-latency service within the measurement gap when the predetermined condition related to a change of service quality is satisfied; or the second indication information may further indicate that the terminal equipment performs reception or transmission of the low-latency service within the measurement gap when the predetermined condition related to service quality is satisfied, in addition to indicating the predetermined condition; however, this embodiment is not limited thereto. In one implementation, when the terminal equipment has a grant configured by the network device, the grant overrides the measurement gap; wherein the grant may be used for reception or transmission of a low-latency service.

In this implementation, the grant overriding the measurement gap may indicate that the grant overrides the entire time period of the measurement gap, or may indicate that the grant overrides a part of time of the measurement gap (such as a part of time when the grant is overlapped with the measurement gap overlap), and this embodiment is not limited thereto.

In this implementation, the grant configured by the network device is a resource preconfigured by the network device for the terminal equipment for performing reception or transmission of a low-latency service. The network device first configures the resource to the terminal equipment, and the terminal equipment performs reception or transmission of a low-latency service on the resource.

In this implementation, when the grant is overlapped with the measurement gap (indicating that the time domain position of the granted resource is overlapped with the measurement gap), the grant configuration overrides the measurement gap. Hence, as the grant pre-configured by the network device has already overridden the measurement gap, the terminal equipment performs reception or transmission of the low-latency service within the grant, which means that the measurement gap is overridden by the grant and will be reserved for the terminal equipment to perform reception or transmission of the low-latency service, and no inter-frequency measurement or inter-RAT measurement is performed in the entire time period or a part of the time period of the measurement gap. Even if an actual low-latency service arrives within the measurement gap, the above-described problem that a terminal equipment adjusts a receiver to an inter-frequency or inter-RAT cell to perform measurement will not occur, that is, reception or transmission of the low-latency service may be performed within the measurement gap.

In this implementation, before step 201, the method may further include (not shown): configuration information transmitted by the network device is received. The configuration information configures that a grant overrides the measurement gap when the terminal equipment has the grant; and furthermore, the configuration information may include information on the number of grants and/or information on the number of measurement gaps. For example, N grants overriding a measurement gap, or a grant overriding M measurement gaps, or N grants overriding M measurement gaps, are configured in the configuration information; however, this embodiment is not limited in thereto. In this embodiment, particular implementations of the above configuration information, the first indication information and the second indication information shall be described in Embodiment 5.

It can be seen from the above embodiment that reception or transmission of the low-latency service is performed within the measurement gap. Hence, when a configured measurement gap occurs in the process of performing reception or transmission of a low-latency service, latency of the low-latency service may be reduced, and user experiences of low-latency service may be ensured.

### Embodiment 3

Embodiment 3 of this disclosure provides a service reception or transmission method, applicable to a terminal equipment side. In this embodiment, on the basis of Embodiment 1, how to perform reception or transmission of the low-latency service when the low-latency service arrives within the measurement gap shall be further described.

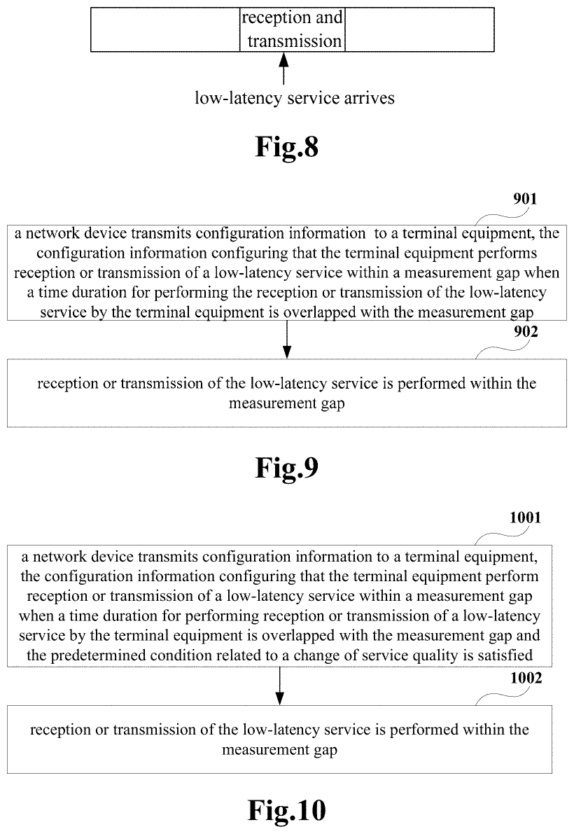

FIG. 8 is a schematic diagram of arrival of the existing low-latency service within the measurement gap. As shown in FIG. 8, the low-latency service arrives in the middle of a measurement gap E. As the measurement gap has been started, and according to existing standards, a terminal equipment has begun a measurement process, and a receiver may have been adjusted to an inter-frequency for performing inter-frequency measurement, or the receiver may have been adjusted to an inter-RAT cell for performing inter-RAT measurement. Hence, in order to avoid latency produced in the low-latency service, in one implementation, the method may further include (not shown):

the measurement gap is overridden by a grant configured by the network device when the terminal equipment has the grant; wherein the grant may be used for performing the reception or transmission of the low-latency service.

In this implementation, the grant overriding the measurement gap may indicate that the grant overrides the entire time period of the measurement gap, or may indicate that the grant overrides a part of time duration of the measurement gap (such as a part of time duration when the grant is overlapped with the measurement gap overlap), and this embodiment is not limited thereto.

In this implementation, the grant configured by the network device is a resource preconfigured by the network device for the terminal equipment for performing reception or transmission of a low-latency service. The network device first configures the resource to the terminal equipment, and the terminal equipment performs reception or transmission of a low-latency service on the resource.

In this implementation, when the grant is overlapped with the measurement gap (indicating that the time domain position of the granted resource is overlapped with the measurement gap), the grant configuration overrides the measurement gap. Hence, as the grant pre-configured by the network device has already overridden the measurement gap, the terminal equipment performs reception or transmission of the low-latency service within the grant, which means that the measurement gap is overridden by the grant and will be reserved for the terminal equipment to perform reception or transmission of the low-latency service, and no inter-frequency measurement or inter-RAT measurement is performed in the entire time period or a part of the time period of the measurement gap. Even if an actual low-latency service arrives within the measurement gap, the above-described problem that a terminal equipment adjusts a receiver to an inter-frequency or inter-RAT cell to perform measurement will not occur, that is, reception or transmission of the low-latency service may be performed within the measurement gap.

In this implementation, before step 201, the method may further include (not shown): configuration information transmitted by the network device is received, the configuration information configuring that a grant overrides the measurement gap when the terminal equipment has the grant; and furthermore, the configuration information may include information on the number of grants and/or information on the number of measurement gaps. For example, N grants overriding a measurement gap, or a grant overriding M measurement gaps, or N grants overriding M measurement gaps, are configured in the configuration information; however, this embodiment is not limited in thereto.

In this implementation, the time duration for performing reception or transmission of the low-latency service being overlapped with the measurement gap includes there existing a low-latency service to be transmitted after measurement is performed within the measurement gap, and the method may further include (not shown): the terminal equipment turns back to a serving cell, proceeds with performing transmission of low-latency services within the measurement gap, and receives acknowledgement of the low-latency service transmitted by the network device.

In this implementation, the terminal equipment starting to perform measurement within the measurement gap indicates that the terminal equipment has adjusted the receiver to inter-frequency for performing inter-frequency measurement, or has adjusted the receiver to an inter-RAT cell for performing inter-RAT measurement, when an uplink low-latency service arrives, the terminal equipment turns back to the serving cell, proceeds with transmission of the low-latency service within a remaining time of the measurement gap, and receives the acknowledgement of the uplink low-latency service transmitted by the network device, so as to reduce latency of the low-latency service.

It can be seen from the above embodiment that reception or transmission of the low-latency service is performed within the measurement gap. Hence, when a configured measurement gap occurs in the process of performing reception or transmission of a low-latency service, latency of the low-latency service may be reduced, and user experiences of low-latency service may be ensured.

### Embodiment 4

Embodiment 4 of this disclosure provides a service reception or transmission method, applicable to a terminal equipment side. In this embodiment, on the basis of Embodiment 1, how to perform reception or transmission of the low-latency service when the low-latency service is received or transmitted by configuring a grant or the low-latency service is received or transmitted in a dynamic scheduling manner (when the low-latency service arrives is unable to be predicted) shall be further described.

In this embodiment, in one implementation, for an uplink low-latency service, the network device may predefine or preconfigure that when the time duration for performing reception or transmission of the low-latency service is overlapped with the measurement gap, the terminal equipment performs reception or transmission of the low-latency service within the measurement gap; and when the terminal equipment has an uplink low-latency service needing to be transmitted and the time duration for performing reception or transmission of the low-latency service is overlapped with the measurement gap, the terminal equipment performs reception or transmission of the low-latency service within the measurement gap according to the predefinition or preconfiguration.

In this implementation, reception or transmission of the low-latency service is performed within a measurement gap, as long as the measurement gap is overlapped with the time duration for performing reception or transmission of the low-latency service, that is, the measurement gap is overridden by the time duration for performing reception or transmission of the low-latency service, and no inter-frequency measurement or inter-RAT measurement is performed in the entire time period or a part of time period of the measurement gap.

In this implementation, the measurement gap may be contained in a set predetermined time period, and the terminal equipment performs reception or transmission of the low-latency service within the predetermined time period.

Reference may be made to Embodiment 2 for a particular implementation process of this implementation, which shall not be described herein any further.

In this embodiment, if service quality of a serving cell where the terminal equipment is located is relatively poor, even if the reception and transmission of the low-latency service is performed within the measurement gap, the low-latency service may not be normally transmitted due to that the service quality is relatively poor. Hence, in this embodiment, when a predetermined condition related to a change of the service quality is satisfied, the reception and transmission of the low-latency service may be performed within the measurement gap. Thus, the quality of the serving cell may be ensured, and a user experience of the low-latency service may be ensured.

Hence, in this embodiment, before performing the reception or transmission of the low-latency service, the method further includes (not shown): the terminal equipment determines that a predetermined condition related to a change of service quality is satisfied; and the terminal equipment performs the reception or transmission of the low-latency service within the measurement gap when the predetermined condition related to a change of service quality is satisfied.

In this embodiment, reference may be made to Embodiment 2 for a particular implementation of the predetermined condition, which shall not be described herein any further.

In this embodiment, the method further includes (not shown): second indication information transmitted by the network device is received, the second indication information indicating the predetermined condition. After receiving the second indication information, the terminal equipment determines the predetermined condition according to the second indication information, determines whether the predetermined condition is satisfied, and performs reception or transmission of the low-latency service within the measurement gap if the predetermined condition is satisfied.

In this embodiment, the method further includes (not shown): configuration information transmitted by the network device is received, the configuration information indicating that the terminal equipment performs reception or transmission of the low-latency service within the measurement gap when the predetermined condition related to a change of service quality is satisfied; or the second indication information may further indicate that the terminal equipment performs reception or transmission of the low-latency service within the measurement gap when the predetermined condition related to a change of service quality is satisfied, in addition to indicating the predetermined condition; however, this embodiment is not limited thereto.

In one implementation, when the terminal equipment has a grant configured by the network device, the grant overrides the measurement gap; wherein the grant may be used for reception or transmission of a low-latency service.

In this implementation, the grant overriding the measurement gap may indicate that the grant overrides the entire time period of the measurement gap, or may indicate that the grant overrides a part of time of the measurement gap (such as a part of time when the grant is overlapped with the measurement gap overlap), and this embodiment is not limited thereto.

In this implementation, the grant configured by the network device is a resource preconfigured by the network device for the terminal equipment for performing reception or transmission of a low-latency service. The network device first configures the resource to the terminal equipment, and the terminal equipment performs reception or transmission of a low-latency service on the resource.

In this implementation, when the grant is overlapped with the measurement gap (indicating that the time domain position of the granted resource is overlapped with the measurement gap), the grant configuration overrides the measurement gap. Hence, as the grant pre-configured by the network device has already overridden the measurement gap, the terminal equipment performs reception or transmission of the low-latency service within the grant, which means that the measurement gap is overridden by the grant and will be reserved for the terminal equipment to perform reception or transmission of the low-latency service, and no inter-frequency measurement or inter-RAT measurement is performed in the entire time period or a part of the time period of the measurement gap. Even if an actual low-latency service arrives within the measurement gap, the above-described problem that a terminal equipment adjusts a receiver to an inter-frequency or inter-RAT cell to perform measurement will not occur, that is, reception or transmission of the low-latency service may be performed within the measurement gap.

In this implementation, before step 201, the method may further include (not shown): configuration information transmitted by the network device is received. The configuration information configures that a grant overrides the measurement gap when the terminal equipment has the grant; and furthermore, the configuration information may include information on the number of grants and/or information on the number of measurement gaps. For example, N grants overriding a measurement gap, or a grant overriding M measurement gaps, or N grants overriding M measurement gaps, are configured in the configuration information; however, this embodiment is not limited in thereto.

In this embodiment, particular implementations of the above configuration information and the second indication information shall be described in Embodiment 5.

It can be seen from the above embodiment that reception or transmission of the low-latency service is performed within the measurement gap. Hence, when a configured measurement gap occurs in the process of performing reception or transmission of a low-latency service, latency of the low-latency service may be reduced, and user experiences of low-latency service may be ensured.

### Embodiment 5

Embodiment 5 of this disclosure provides a service reception or transmission method, applicable to a network device side. As a principle of the method is similar to those of the methods of embodiments 1-4, reference may be made to implementations of the methods of embodiments 1-4 for particular implementation of this method, with identical contents being not going to be described herein any further.

FIG. 9 is a flowchart of the service reception or transmission method of this embodiment. As shown in FIG. 9, the method includes:

step 901: a network device transmits configuration information to a terminal equipment, the configuration information configuring that the terminal equipment performs reception or transmission of a low-latency service within a measurement gap when a time duration for performing the reception or transmission of the low-latency service by the terminal equipment is overlapped with the measurement gap.

In this embodiment, the terminal equipment may perform the reception or transmission of the low-latency service within the measurement gap according to the configuration information. Hence, when a configured measurement gap occurs in the process of performing reception or transmission of a low-latency service, latency of the low-latency service may be reduced, and user experiences of low-latency service may be ensured.

In this embodiment, the configuration information may be transmitted via RRC signaling or MAC signaling or physical layer signaling. For example, the configuration information may include a predefined field measGAPoverride, and the field appeared in the configuration information indicates configuring that the terminal equipment performs reception or transmission of the low-latency service within the measurement gap when the time duration for performing reception or transmission of the low-latency service by the terminal equipment is overlapped with the measurement gap, or a value of the field being 1 indicates configuring that the terminal equipment performs reception or transmission of the low-latency service within the measurement gap when the time duration for performing reception or transmission of the low-latency service by the terminal equipment is overlapped with the measurement gap; however, this is an example only, and this embodiment is not limited thereto.

In this embodiment, the configuration information indicates that the terminal equipment performs reception or transmission of the low-latency service within a measurement gap, as long as the measurement gap is overlapped with the time duration for performing reception or transmission of the low-latency service, that is, the measurement gap is overridden by the time duration for performing reception or transmission of the low-latency service, and no inter-frequency measurement or inter-RAT measurement is performed.

In this embodiment, the method may further include:

step 902 (optional): reception or transmission of the low-latency service is performed within the measurement gap.

In step 902, at the network device side, the performing transmission of the low-latency service denotes that the low-latency service is a downlink low-latency service, and the performing reception of the low-latency service denotes that the low-latency service is an uplink low-latency service.

In this embodiment, before step 902, the method may further include (not shown): the network device transmits second indication information to the terminal equipment, the second indication information indicating a predetermined condition related to a change of service quality; wherein the terminal equipment may determine according to the configuration information and the second indication information that performing reception and transmission of the low-latency service within the measurement gap when the predetermined condition indicated by the second indication information is satisfied and the time duration for performing reception and transmission of the low-latency service is overlapped with the measurement gap. Reference may be made to Embodiment 2 for a meaning of the predetermined condition, which shall not be described herein any further.

In this embodiment, the second indication information may be transmitted via RRC signaling or MAC signaling or physical layer signaling, and the second indication information may be transmitted together with the above configuration information, or may be transmitted separately, and this embodiment is not limited thereto.

FIG. 10 is a flowchart of the service reception or transmission method of this embodiment. As shown in FIG. 10, the method includes:

step 1001: a network device transmits configuration information to a terminal equipment, the configuration information configuring that the terminal equipment perform reception or transmission of a low-latency service within a measurement gap when a time duration for performing reception or transmission of a low-latency service by the terminal equipment is overlapped with the measurement gap and the predetermined condition related to a change of service quality is satisfied.

In this embodiment, the configuration information may be transmitted via RRC signaling or MAC signaling or physical layer signaling. For example, the configuration information may include a field measGAPoverride and a field triggerevent. The above two fields appearing in the configuration information indicates configuring that the terminal equipment perform reception or transmission of the low-latency service within the measurement gap when the time duration for performing reception or transmission of a low-latency service by the terminal equipment is overlapped with the measurement gap and the predetermined condition related to a change of service quality is satisfied, or a value of the field measGAPoverride being 1 and the field triggerevent indicating a predetermined condition indicate configuring that the terminal equipment perform reception or transmission of the low-latency service within the measurement gap when the time duration for performing reception or transmission of a low-latency service by the terminal equipment is overlapped with the measurement gap and the predetermined condition related to a change of service quality is satisfied; however, this is an example only, and this embodiment is not limited thereto.

In this embodiment, the method may further include (not shown, optional): the network device transmits second indication information to the terminal equipment, the second indication information indicating the predetermined condition. Reference may be made to Embodiment 2 for a meaning of the predetermined condition, which shall not be described herein any further.

In this embodiment, the second indication information may be transmitted via RRC signaling or MAC signaling or physical layer signaling, and may be transmitted together with the above configuration information, or may be transmitted separately, and this embodiment is not limited thereto.

In this embodiment, the method may further include:

step 1002 (optional): reception or transmission of the low-latency service is performed within the measurement gap.

In step 1002, at the network device side, the performing transmission of the low-latency service denotes that the low-latency service is a downlink low-latency service, and the performing reception of the low-latency service denotes that the low-latency service is an uplink low-latency service.

In this embodiment, before step 1002, the method may further include (optional, not shown): a measurement report transmitted by the terminal equipment is received, the network device determines whether the predetermined condition is satisfied according to the measurement report, and executes step 1002 if the predetermined condition is satisfied; however, this embodiment is not limited thereto.

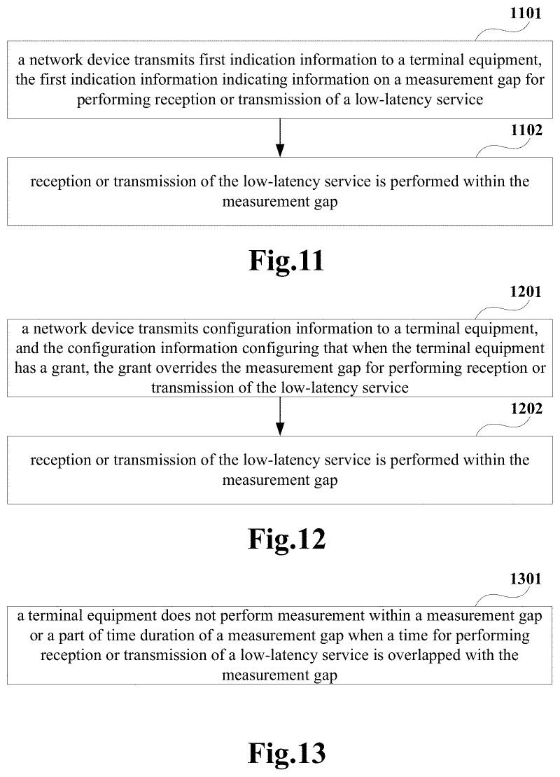

FIG. 11 is a flowchart of the service reception or transmission method of this embodiment. As shown in FIG. 11, the method includes:

step 1101: a network device transmits first indication information to a terminal equipment, the first indication information indicating information on a measurement gap for performing reception or transmission of a low-latency service.

In this embodiment, when the time duration for performing reception or transmission of the low-latency service is overlapped with the measurement gap, the terminal equipment determines to perform reception or transmission of the low-latency service within the measurement gap according to the first indication information.

In this embodiment, reception or transmission of the low-latency service is performed in a measurement gap, as long as the measurement gap is indicated in the first indication information, that is, the measurement gap is overridden by the time duration for performing reception or transmission of the low-latency service, without needing to perform inter-frequency measurement or inter-RAT measurement.

In this implementation, reference may be made to Embodiment 2 for particular implementation of the information on the measurement gap, which shall not be described herein any further.

In this implementation, the first indication information is carried by a downlink control channel (PDCCH), or medium access control (MAC) or radio resource control (RRC) signaling.

In this implementation, the network device needs to transmit the first indication information before the overridden measurement gap; however, a particular time duration for transmitting the first indication information is not limited in this embodiment.

In this embodiment, the method may further include:

step 1102 (optional): reception or transmission of the low-latency service is performed within the measurement gap.

In step 1102, at the network device side, the performing transmission of the low-latency service denotes that the low-latency service is a downlink low-latency service, and the performing reception of the low-latency service denotes that the low-latency service is an uplink low-latency service.

In this embodiment, before step 1102, the method may further include (not shown): the network device transmits second indication information to the terminal equipment, the second indication information indicating a predetermined condition related to a change of service quality; wherein the terminal equipment may determine according to the first indication information and the second indication information to perform reception and transmission of the low-latency service within the measurement gap indicated by the first indication information when the time duration for performing reception and transmission of the low-latency service is overlapped with the measurement gap and the predetermined condition indicated by the second indication information is satisfied. Reference may be made to Embodiment 2 for a meaning of the predetermined condition, which shall not be described herein any further.

In this embodiment, the second indication information may be transmitted via RRC signaling or MAC signaling or physical layer signaling, and the first indication information and the second indication information may be transmitted together in a message or a piece of signaling, or may be transmitted separately, and an order of transmitting the first indication information and the second indication information is not limited in this embodiment.

FIG. 12 is a flowchart of the service reception or transmission method of this embodiment. As shown in FIG. 12, the method includes:

step 1201: a network device transmits configuration information to a terminal equipment, and the configuration information configuring that when the terminal equipment has a grant, the grant overrides the measurement gap for performing reception or transmission of the low-latency service.

In this implementation, the grant configured by the network device is a resource preconfigured by the network device for the terminal equipment for performing reception or transmission of a low-latency service. The network device first configures the resource to the terminal equipment, and the terminal equipment performs reception or transmission of a low-latency service on the resource.

In this embodiment, the configuration information may be transmitted to the terminal equipment before the network device configures the grant for the terminal equipment, or may be transmitted to the terminal equipment after the network device configures the grant for the terminal equipment, and this embodiment is not limited thereto.

In this implementation, the grant overriding the measurement gap may indicate that the grant overrides the entire time period of the measurement gap, or may indicate that the grant overrides a part of time of the measurement gap (such as a part of time when the grant is overlapped with the measurement gap overlap), and this embodiment is not limited thereto.

In this embodiment, the configuration information may be transmitted via RRC signaling or MAC signaling or physical layer signaling. For example, the configuration information may include a field measGAPoverridebygrant, and the field appeared in the configuration information indicates that when the terminal equipment has a grant, the grant overrides the measurement gap, or a value of the field being 1 indicates that when the terminal equipment has a grant, the grant overrides the measurement gap. This is an example only, and this embodiment is not limited thereto. Furthermore, the configuration information may include information on the number of grants and/or information on the number of measurement gaps. For example, in the configuration information, N grants are configured to override a measurement gap, or a grant is configured to override M measurement gaps, or N grants are configured to override M measurement gaps; however, this embodiment is not limited in thereto.

In this embodiment, the method may further include (not shown): the network device configures a grant for the terminal equipment, the grant being able to be used for receiving or transmitting a low-latency service; wherein as the network device also configures a measurement gap for the terminal equipment, when the grant is overlapped with a configured measurement gap, the grant is configured to override the measurement gap (which may override the entire time period of the measurement gap, or a part of the time period of the measurement gap, such as the above overlapped time period). Hence, as the grant pre-configured by the network device has overridden the measurement gap, the terminal equipment performs reception or transmission of the low-latency service within the grant, which means that the measurement gap is overridden by the grant and will be reserved for the terminal equipment for performing reception or transmission of the low-latency service, without performing inter-frequency measurement or inter-RAT measurement. Even if an actual low-latency service arrives within the measurement gap, the above-described problem that a terminal equipment adjusts a receiver to an inter-frequency or inter-RAT cell to perform measurement will not occur, that is, reception or transmission of the low-latency service may be performed within the measurement gap.

In this embodiment, the grant may be transmitted together with the configuration information, or may be transmitted separately, or only the configuration information may be transmitted. Reference may be made to the related art for the grant, and the grant may be transmitted by using RRC signaling, and this embodiment is not limited thereto.

In this embodiment, the method may further include:

step 1202 (optional): reception or transmission of the low-latency service is performed within the measurement gap.

In step 1202, at the network device side, the performing transmission of the low-latency service denotes that the low-latency service is a downlink low-latency service, and the performing reception of the low-latency service denotes that the low-latency service is an uplink low-latency service.

It can be seen from the above embodiment that reception or transmission of the low-latency service is performed within the measurement gap. Hence, when a configured measurement gap occurs in the process of performing reception or transmission of a low-latency service, latency of the low-latency service may be reduced, and user experiences of low-latency service may be ensured.

### Embodiment 6

Embodiment 6 of this disclosure provides a measurement method. FIG. 13 is a flowchart of the measurement method in this embodiment, which is applied to a terminal equipment side. As shown in FIG. 13, the method includes:

step 1301: a terminal equipment does not perform measurement within a measurement gap or a part of time of a measurement gap when a time duration for performing reception or transmission of a low-latency service is overlapped with the measurement gap.

In this embodiment, in step 1301, the terminal equipment does not perform measurement within the measurement gap or a part of time of the measurement gap. Hence, the measurement gap may be used to for performing reception or transmission of the low-latency service.

In this embodiment, reference may be made to embodiments 1-4 for a particular implementation of performing reception or transmission of the low-latency service within the measurement gap, which shall not be described herein any further.

In this embodiment, the method may further include (optional, not shown): configuration information transmitted by a network device is received, the configuration information configuring that a terminal equipment does not perform measurement within a measurement gap when a time duration for performing the reception or transmission of the low-latency service by the terminal equipment is overlapped with the measurement gap, or when a time duration for performing the reception or transmission of the low-latency service by the terminal equipment is overlapped with the measurement gap and a predetermined condition related to a change of service quality is satisfied;

or the configuration information configuring that when a terminal equipment has a grant, the grant overrides a measurement gap in which no measurement is performed;

or, receiving first indication information transmitted by a network device, the first indication information indicating information on the measurement gap in which no measurement is performed.

In this embodiment, the method may further include (optional, not shown): second indication information transmitted by the network device is received, the second indication information indicating a predetermined condition related to a change of service quality. The terminal equipment does not perform measurement within the measurement gap or the part of the time of the measurement gap if the predetermined condition is satisfied.

In this embodiment, particular implementations of the configuration information, the first indication information and the second indication information are similar to those in embodiments 1-5, which shall not be described herein any further.

It can be seen from the above embodiment that measurement is not performed within the measurement gap, that is, reception or transmission of the low latency service is performed.

Hence, when a configured measurement gap occurs in the process of performing reception or transmission of a low-latency service, latency of the low-latency service may be reduced, and user experiences of low-latency service may be ensured.

### Embodiment 7

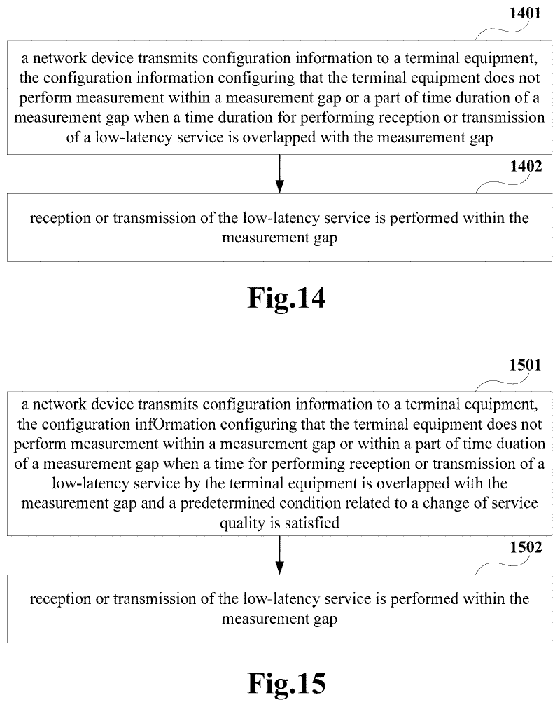

Embodiment 7 of this disclosure provides a measurement method. FIG. 14 is a flowchart of the measurement method in this embodiment, which is applied to a network device side. As shown in FIG. 14, the method includes:

step 1401: a network device transmits configuration information to a terminal equipment, the configuration information configuring that the terminal equipment does not perform measurement within a measurement gap or a part of time of a measurement gap when a time duration for performing reception or transmission of a low-latency service is overlapped with the measurement gap.

In this embodiment, the configuration information denotes a measurement gap overlapped with the time duration for performing the reception or transmission of the low-latency service, that is, a measurement gap overridden by the time duration for performing the reception or transmission of the low-latency service, and the terminal equipment does not need to perform inter-frequency measurement or inter-RAT measurement.

In this embodiment, the method may further include:

step 1402 (optional): reception or transmission of the low-latency service is performed within the measurement gap.

In step 1402, at the network device side, the performing transmission of the low-latency service denotes that the low-latency service is a downlink low-latency service, and the performing reception of the low-latency service denotes that the low-latency service is an uplink low-latency service.

In this embodiment, before step 1402, the method may further include (not shown): the network device transmits second indication information transmitted to the terminal equipment, the second indication information indicating a predetermined condition related to a change of service quality. The terminal equipment may determine according to the configuration information and the second indication information that measurement is not performed within the measurement gap or the part of the time of the measurement gap when the time duration for performing reception or transmission of the low-latency service is overlapped with the measurement gap and the predetermined condition indicated by the second indication information is satisfied. Reference may be made to Embodiment 2 for a meaning of the predetermined condition, which shall not be described herein any further.

FIG. 15 is a flowchart of the measurement method in this embodiment. As shown in FIG. 15, the method includes:

step 1501: a network device transmits configuration information to a terminal equipment, the configuration information configuring that the terminal equipment does not perform measurement within a measurement gap or within a part of time of a measurement gap when a time duration for performing reception or transmission of a low-latency service by the terminal equipment is overlapped with the measurement gap and a predetermined condition related to a change of service quality is satisfied.

In this embodiment, the method may further include (not shown, optional): the network device transmits second indication information transmitted to the terminal equipment, the second indication information indicating the predetermined condition. Reference may be made to Embodiment 2 for a meaning of the predetermined condition, which shall not be described herein any further.

In this embodiment, the method may further include:

step 1502 (optional): reception or transmission of the low-latency service is performed within the measurement gap.

In step 1502, at the network device side, the performing transmission of the low-latency service denotes that the low-latency service is a downlink low-latency service, and the performing reception of the low-latency service denotes that the low-latency service is an uplink low-latency service.

In this embodiment, before step 1502, the method may further include (optional, not shown): the network device receives a measurement report transmitted by the terminal equipment, determines whether the predetermined condition is satisfied according to the measurement report, and executing step 1502 if the predetermined condition is satisfied; however, this embodiment is not limited thereto.

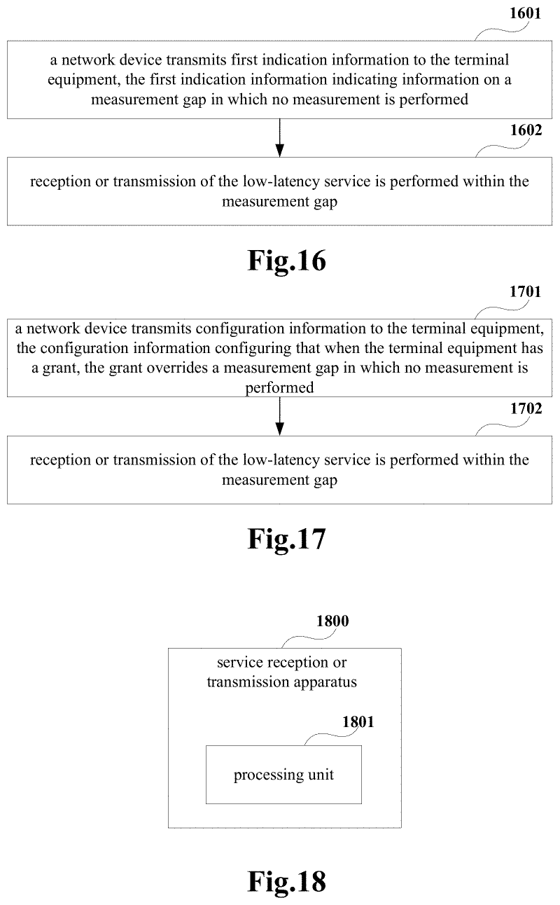

FIG. 16 is a flowchart of the measurement method of this embodiment. As shown in FIG. 16, the method includes:

step 1601: a network device transmits first indication information to the terminal equipment, the first indication information indicating information on a measurement gap in which no measurement is performed.

In this implementation, when the time duration for performing reception or transmission of the low-latency service is overlapped with the measurement gap, the terminal equipment determines not to perform measurement within the measurement gap according to the first indication information.

In this implementation, measurement is not performed in the measurement gap indicated in the first indication information or a part of time of the measurement gap, that is, the measurement gap is overridden by the time duration for performing reception or transmission of the low-latency service, without needing to perform inter-frequency measurement or inter-RAT measurement.

In this implementation, reference may be made to Embodiment 2 for particular implementation of the information on the measurement gap, which shall not be described herein any further.

In this implementation, the first indication information is carried by a downlink control channel (PDCCH), or medium access control (MAC) or radio resource control (RRC) signaling.

In this implementation, the network device needs to transmit the first indication information before the overridden measurement gap; however, a particular time duration for transmitting the first indication information is not limited in this embodiment.

In this embodiment, the method may further include:

step 1602 (optional): reception or transmission of the low-latency service is performed within the measurement gap.

In step 1602, at the network device side, the performing transmission of the low-latency service denotes that the low-latency service is a downlink low-latency service, and the performing reception of the low-latency service denotes that the low-latency service is an uplink low-latency service.

In this embodiment, before step 1602, the method may further include (not shown, not shown): the network device transmits second indication information to the terminal equipment, the second indication information indicating a predetermined condition related to a change of service quality; wherein the terminal equipment may determine according to the first indication information and the second indication information to perform reception and transmission of the low-latency service within the measurement gap indicated by the first indication information when the time duration for performing reception and transmission of the low-latency service is overlapped with the measurement gap and the predetermined condition indicated by the second indication information is satisfied. Reference may be made to Embodiment 2 for a meaning of the predetermined condition, which shall not be described herein any further.

FIG. 17 is a flowchart of the measurement method of this embodiment. As shown in FIG. 17, the method includes:

step 1701: a network device transmits configuration information to the terminal equipment, the configuration information configuring that when the terminal equipment has a grant, the grant overrides a measurement gap in which no measurement is performed.

In this implementation, the grant overriding the measurement gap may indicate that the grant overrides the entire time period of the measurement gap, or may indicate that the grant overrides a part of time of the measurement gap (such as a part of time when the grant is overlapped with the measurement gap overlap), and this embodiment is not limited thereto.

In this implementation, the grant configured by the network device is a resource preconfigured by the network device for the terminal equipment for performing reception or transmission of a low-latency service. The network device first configures the resource to the terminal equipment, and the terminal equipment performs reception or transmission of a low-latency service on the resource.

In this implementation, when the grant is overlapped with the measurement gap (indicating that the time domain position of the granted resource is overlapped with the measurement gap), the grant configuration overrides the measurement gap. Hence, as the grant pre-configured by the network device has already overridden the measurement gap, the terminal equipment performs reception or transmission of the low-latency service within the grant, which means that the measurement gap is overridden by the grant and will be reserved for the terminal equipment to perform reception or transmission of the low-latency service, and no inter-frequency measurement or inter-RAT measurement is performed. Even if an actual low-latency service arrives within the measurement gap, the above-described problem that a terminal equipment adjusts a receiver to an inter-frequency or inter-RAT cell to perform measurement will not occur, that is, reception or transmission of the low-latency service may be performed within the measurement gap.

In this implementation, the method may further include (not shown): configuration information transmitted by the network device is received. The configuration information configures that a grant overrides the measurement gap when the terminal equipment has the grant; and furthermore, the configuration information may include information on the number of grants and/or information on the number of measurement gaps. For example, N grants overriding a measurement gap, or a grant overriding M measurement gaps, or N grants overriding M measurement gaps, are configured in the configuration information; however, this embodiment is not limited in thereto.

In this embodiment, the method may further include:

step 1702 (optional): reception or transmission of the low-latency service is performed within the measurement gap.

In step 1702, at the network device side, the performing transmission of the low-latency service denotes that the low-latency service is a downlink low-latency service, and the performing reception of the low-latency service denotes that the low-latency service is an uplink low-latency service.

In this embodiment, particular implementations of the above configuration information, the first indication information and the second indication information are similar to those in Embodiment 5, which shall not be described herein any further.

It can be seen from the above embodiment that measurement is not performed within the measurement gap, that is, reception or transmission of the low latency service is performed. Hence, when a configured measurement gap occurs in the process of performing reception or transmission of a low-latency service, latency of the low-latency service may be reduced, and user experiences of low-latency service may be ensured.

### Embodiment 8

Embodiment 8 of this disclosure provides a service reception or transmission apparatus. As a principle of the apparatus for solving problems is similar to those of the methods in embodiments 1-4, reference may be made to the implementations of the methods in embodiments 1-4 for implementation of the apparatus, with identical contents being not going to be described herein any further.

FIG. 18 is a schematic diagram of the service reception or transmission apparatus of Embodiment 8 of this disclosure. As shown in FIG. 18, a service reception or transmission apparatus 1800 includes:

a processing unit 1801 configured to perform reception or transmission of a low-latency service within a measurement gap when a time duration for performing reception or transmission of the low-latency service is overlapped with the measurement gap.

In this embodiment, the processing unit 1801 may transmit the low-latency service and/or transmit information on the low-latency service within the measurement gap.

In this embodiment, the apparatus may further include:

a determining unit (not shown, optional) configured to determine whether a predetermined condition related to a change of service quality is satisfied;

and when a determination result of the determining unit is that the predetermined condition related to a change of service quality is satisfied, the processing unit 1801 performs the reception or transmission of the low-latency service within the measurement gap.

In this embodiment, reference may be made to Embodiment 2 for details of the predetermined condition, which shall not be described herein any further.

In this embodiment, the apparatus may further include:

a second receiving unit (not shown, optional) configured to receive second indication information transmitted by the network device, the second indication information indicating the predetermined condition.

In this embodiment, when the time duration for performing reception or transmission of the low-latency service being overlapped with the measurement gap includes there existing a low-latency service to be transmitted after measurement has been performed within the measurement gap, the processing unit 1801 is further configured to turn back to a serving cell, proceed with performing transmission of low-latency services within the measurement gap, and receive acknowledgement of the low-latency service transmitted by the network device.

In one implementation, the measurement gap is contained in a set predetermined time period, and the processing unit 1801 performs the reception or transmission of the low-latency service within the predetermined time period.

In this implementation, the apparatus further includes:

a setting unit (not shown) configured to set the predetermined time period when a low-latency service is received or transmitted in advance.

In this implementation, the processing unit 1801 is further configured to perform measurement within a measurement gap after the predetermined time period when no low-latency service is received within the predetermined time period or no low-latency service is transmitted within the predetermined time period.

In this implementation, the setting unit sets the predetermined time period by starting a timer.

In one implementation, the apparatus further includes:

a first receiving unit (not shown) configured to receive first indication information transmitted by a network device, the first indication information indicating information on the measurement gap for performing the reception or transmission of the low-latency service.

In this implementation, the first indication information is carried by a downlink control channel or medium access control signaling or radio resource control signaling. Reference may be made to Embodiment 2 for the information on the measurement gap, which shall not be described herein any further.

In this embodiment, when the terminal equipment has a grant configured by the network device, the grant overrides the measurement gap for performing the reception or transmission of the low-latency service.

In this embodiment, the apparatus further includes:

a third receiving unit (not shown) configured to receive configuration information transmitted by the network device, the configuration information configuring that a terminal equipment performs reception or transmission of a low-latency service within a measurement gap when a time duration for performing the reception or transmission of the low-latency service by the terminal equipment is overlapped with the measurement gap, or when a time duration for performing the reception or transmission of the low-latency service by the terminal equipment is overlapped with the measurement gap and a predetermined condition related to a change of service quality is satisfied;

or the configuration information configuring that when a terminal equipment has a grant for a low-latency service, the grant overrides the measurement gap for performing the reception or transmission of the low-latency service.

In this embodiment, in performing the reception or transmission of the low-latency service within the measurement gap, the processing unit 1801 does not perform measurement.

In this embodiment, reference may be made to embodiments 1-4 for particular implementations of the above unit, which shall not be described herein any further.

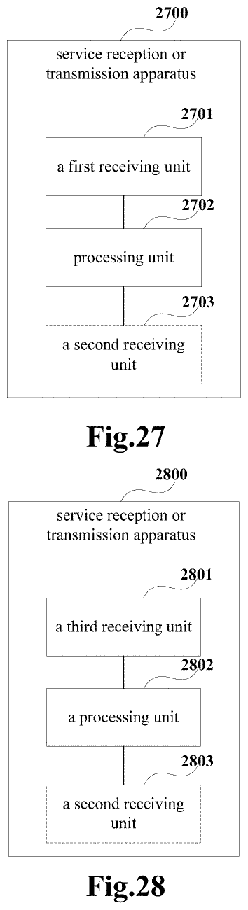

FIGS. 26-28 are schematic diagrams of structures of three implementations of the service reception or transmission apparatus. As shown in FIG. 26, a service reception or transmission apparatus 2600 includes a third receiving unit 2601, a setting unit 2602 and a processing unit 2603. And optionally, it may further include a second receiving unit 2604. As shown in FIG. 27, a service reception or transmission apparatus 2700 includes a first receiving unit 2701 and a processing unit 2702. And optionally, it may further include a second receiving unit 2703. As shown in FIG. 28, a service reception or transmission apparatus 2800 includes a third receiving unit 2801 and a processing unit 2802. And optionally, it may further include a second receiving unit 2803. Particular implementations of the units are as described above, and shall not be described herein any further.

It can be seen from the above embodiment that reception or transmission of the low-latency service is performed within the measurement gap. Hence, when a configured measurement gap occurs in the process of performing reception or transmission of a low-latency service, latency of the low-latency service may be reduced, and user experiences of low-latency service may be ensured.

### Embodiment 9

Embodiment 9 of this disclosure provides a terminal equipment. As a principle of the device for solving problems is similar to those of the methods in embodiments 1-4, reference may be made to the implementations of the methods in embodiments 1-4 for implementation of the device, with identical contents being not going to be described herein any further.

This embodiment further provides a terminal equipment (not shown), configured with the above-described service reception or transmission apparatus 1800.

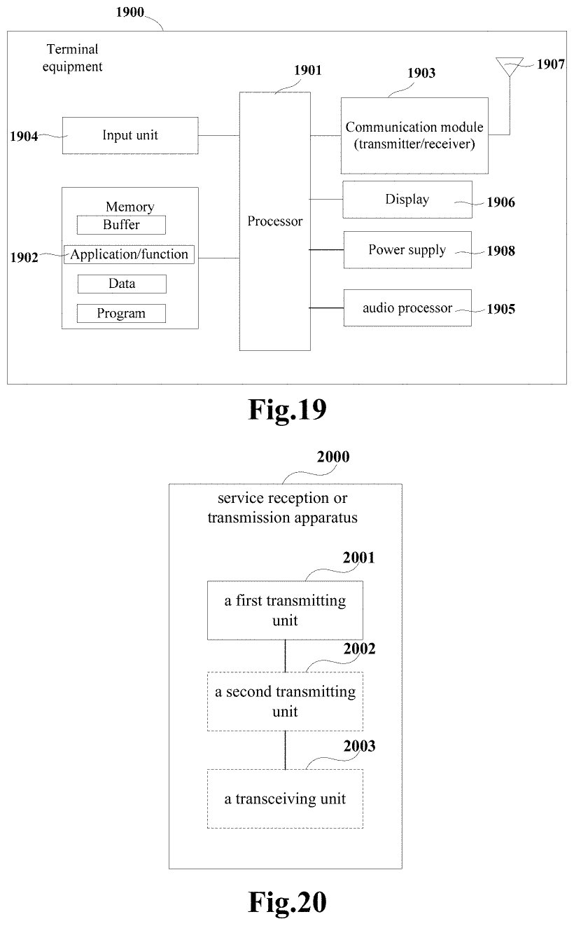

This embodiment further provides a terminal equipment. FIG. 19 is a schematic diagram of a structure of the terminal equipment of Embodiment 9 of this disclosure. As shown in FIG. 19, the terminal equipment 1900 may include a central processing unit (CPU) 1901 and a memory 1902, the memory 1902 being coupled to the central processing unit 1901. The memory 1902 may store various data, and furthermore, it may store a program for data processing, and execute the program under control of the central processing unit 1901, so as to perform reception or transmission of services.

In one implementation, the functions of the service reception or transmission apparatus 1800 may be integrated into the central processing unit 1901, wherein the central processing unit 1901 may be configured to carry out the service reception or transmission methods described in embodiments 1-4.

For example, the central processing unit 1901 may be configured to: perform reception or transmission of a low-latency service within a measurement gap when a time duration for performing reception or transmission of the low-latency service is overlapped with the measurement gap.

In one implementation, the central processing unit 1901 may further be configured that the measurement gap is contained in a set predetermined time period, and reception or transmission of the low-latency service is performed within the predetermined time period.

In one implementation, the central processing unit 1901 may further be configured to: set the predetermined time period when a low-latency service is received or transmitted in advance.

In one implementation, the central processing unit 1901 may further be configured to: perform measurement within a measurement gap after the predetermined time period when no low-latency service is received within the predetermined time period or no low-latency service is transmitted within the predetermined time period.

In one implementation, the central processing unit 1901 may further be configured to: set the predetermined time period by starting a timer.

In one implementation, the central processing unit 1901 may further be configured to: transmit the low-latency service and/or information on the low-latency service within the measurement gap.

In one implementation, the central processing unit 1901 may further be configured to:

receive first indication information transmitted by a network device, the first indication information indicating information on the measurement gap for performing the reception or transmission of the low-latency service.

In one implementation, the central processing unit 1901 may further be configured to: determine a predetermined condition related to a change of service quality is satisfied, and when the predetermined condition related to a change of service quality is satisfied, perform the reception or transmission of the low-latency service within the measurement gap.

In one implementation, the central processing unit 1901 may further be configured to: receive second indication information transmitted by the network device, the second indication information indicating the predetermined condition.

In one implementation, the central processing unit 1901 may further be configured to: when the time duration for performing reception or transmission of the low-latency service being overlapped with the measurement gap includes there existing a low-latency service to be transmitted after measurement has been performed within the measurement gap, turn back to a serving cell, proceed with performing transmission of low-latency services within the measurement gap, and receive acknowledgement of the low-latency service transmitted by the network device.

In one implementation, the central processing unit 1901 may further be configured so that when a terminal equipment has a grant configured by the network device, the grant overrides the measurement gap for performing the reception or transmission of the low-latency service.

In one implementation, the central processing unit 1901 may further be configured to: receive configuration information transmitted by the network device, the configuration information configuring that a terminal equipment performs reception or transmission of a low-latency service within a measurement gap when a time duration for performing the reception or transmission of the low-latency service by the terminal equipment is overlapped with the measurement gap, or when a time duration for performing the reception or transmission of the low-latency service by the terminal equipment is overlapped with the measurement gap and a predetermined condition related to a change of service quality is satisfied, or the configuration information configuring that when a terminal equipment has a grant for a low-latency service, the grant overrides a measurement gap for performing reception or transmission of a low-latency service.

In one implementation, the central processing unit 1901 may further be configured not to perform measurement in performing the reception or transmission of the low-latency service within the measurement gap.

Furthermore, reference may be made to embodiments 1-4 for other configuration manners of the central processing unit 1901, which shall not be described herein any further.

In another implementation, the above apparatus 1800 and the central processing unit 1901 may be configured separately; for example, the apparatus 1800 may be configured as a chip connected to the central processing unit 1901, and the functions of the apparatus 1800 are executed under control of the central processing unit 1901.

Furthermore, as shown in FIG. 19, the terminal equipment 1900 may include a communication module 1903, an input unit 1904, a display 1906, an audio processor 1905, an antenna 1907 and a power supply 1908, etc. Functions of the above components are similar to those in the related art, and shall not be described herein any further. It should be noted that the terminal equipment 1900 does not necessarily include all the parts shown in FIG. 19. Furthermore, the terminal equipment 1900 may include parts not shown in FIG. 19, and the related art may be referred to.

It can be seen from the above embodiment that reception or transmission of the low-latency service is performed within the measurement gap. Hence, when a configured measurement gap occurs in the process of performing reception or transmission of a low-latency service, latency of the low-latency service may be reduced, and user experiences of low-latency service may be ensured.

### Embodiment 10

Embodiment 10 of this disclosure provides a service reception or transmission apparatus. As a principle of the apparatus for solving problems is similar to that of the method in Embodiment 5, reference may be made to the implementation of the method in Embodiment 5 for implementation of the apparatus, with identical contents being not going to be described herein any further.

FIG. 20 is a schematic diagram of the service reception or transmission apparatus of Embodiment 10 of this disclosure. As shown in FIG. 20, a service reception or transmission apparatus 2000 includes:

a first transmitting unit 2001 configured to transmit configuration information to a terminal equipment, the configuration information configuring that the terminal equipment performs reception or transmission of a low-latency service within a measurement gap when a time duration for performing the reception or transmission of the low-latency service by the terminal equipment is overlapped with the measurement gap, or when a time duration for performing the reception or transmission of the low-latency service by the terminal equipment is overlapped with the measurement gap and a predetermined condition related to a change of service quality is satisfied;

or the configuration information configuring that when the terminal equipment has a grant, the grant overrides a measurement gap for performing reception or transmission of a low-latency service;

or transmit first indication information to a terminal equipment, the first indication information indicating information on a measurement gap for performing reception or transmission of a low-latency service.

In this embodiment, the apparatus may further include:

a second transmitting unit 2002 (optional) configured to transmit second indication information to the terminal equipment, the second indication information indicating the predetermined condition.

In this embodiment, the apparatus may further include:

a transceiving unit 2003 (optional) configured to perform the reception or transmission of the low-latency service within the measurement gap.

In this embodiment, reference may be made to Embodiment 5 for implementations of the above units, which shall not be described herein any further. Actions of the reception or transmission may be conducted by a transmitter or a receiver (a transmission antenna or a receiving antenna), and this embodiment is not limited thereto.

It can be seen from the above embodiment that reception or transmission of the low-latency service is performed within the measurement gap. Hence, when a configured measurement gap occurs in the process of performing reception or transmission of a low-latency service, latency of the low-latency service may be reduced, and user experiences of low-latency service may be ensured.

### Embodiment 11

Embodiment 11 of this disclosure provides a network device. As a principle of the device for solving problems is similar to that of the method in Embodiment 5, reference may be made to the implementation of the method in Embodiment 5 for implementation of the device, with identical contents being not going to be described herein any further.

This embodiment further provides a network device (not shown), configured with the above-described service reception or transmission apparatus 2000.

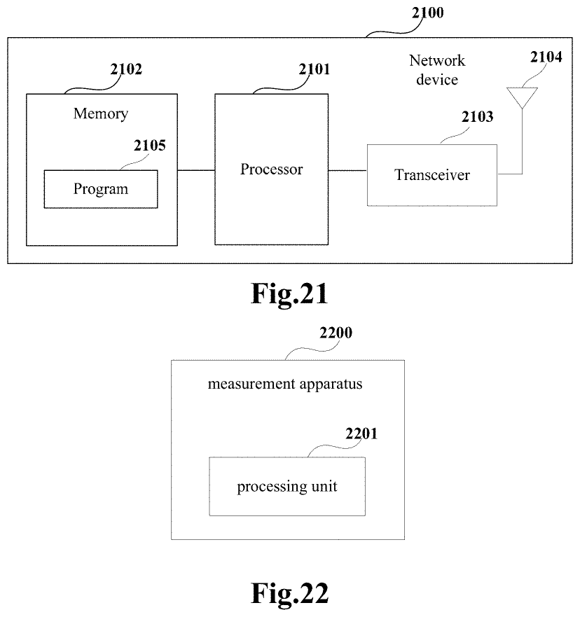

Embodiment 11 of this disclosure further provides a network device. As a principle of the device for solving problems is similar to that of the method in Embodiment 1, reference may be made to the implementation of the method in Embodiment 1 for implementation of the device, with identical contents being not going to be described herein any further. FIG. 21 is a schematic diagram of a structure of the network device. As shown in FIG. 21, a network device 2100 may include a central processing unit (CPU) 2101 and a memory 2102, the memory 2102 being coupled to the central processing unit 2101. The memory 2102 may store various data, and furthermore, it may store a program 2105 for data processing, and execute the program under control of the central processing unit 2101, so as to transmit services.

In one implementation, the functions of the apparatus 2000 may be integrated into the central processing unit 2101, wherein the central processing unit 2101 may be configured to carry out the service reception or transmission method described in Embodiment 5.

For example, the central processing unit 2101 may be configured to: transmit configuration information to a terminal equipment, the configuration information configuring that the terminal equipment performs reception or transmission of a low-latency service within a measurement gap when a time duration for performing the reception or transmission of the low-latency service by the terminal equipment is overlapped with the measurement gap, or when a time duration for performing the reception or transmission of the low-latency service by the terminal equipment is overlapped with the measurement gap and a predetermined condition related to a change of service quality is satisfied;

or the configuration information configuring that when the terminal equipment has a grant, the grant overrides the measurement gap for performing the reception or transmission of the low-latency service;

or transmit first indication information to a terminal equipment, the first indication information indicating information on a measurement gap for performing reception or transmission of a low-latency service.

In one implementation, the central processing unit 2101 may further be configured to: transmit second indication information to the terminal equipment, the second indication information indicating the predetermined condition.

In one implementation, the central processing unit 2101 may further be configured to: perform the reception or transmission of the low-latency service within the measurement gap.

Furthermore, reference may be made to Embodiments 5 for a particular configuration manner of the central processing unit 2101, which shall not be described herein any further.

In another implementation, the above apparatus 2000 and the central processing unit 2101 may be configured separately; for example, the apparatus 2000 may be configured as a chip connected to the central processing unit 2101, and the functions of the apparatus 2000 are executed under control of the central processing unit 2101.

Furthermore, as shown in FIG. 21, the network device 2100 may include a transceiver 2103, and an antenna 2104, etc. Functions of the above components are similar to those in the related art, and shall not be described herein any further. It should be noted that the network device 2100 does not necessarily include all the parts shown in FIG. 19. Furthermore, the network device 2100 may include parts not shown in FIG. 21, and the related art may be referred to.

It can be seen from the above embodiment that reception or transmission of the low-latency service is performed within the measurement gap. Hence, when a configured measurement gap occurs in the process of performing reception or transmission of a low-latency service, latency of the low-latency service may be reduced, and user experiences of low-latency service may be ensured.

### Embodiment 12

Embodiment 12 of this disclosure provides a measurement apparatus. As a principle of the apparatus for solving problems is similar to that of the method in embodiment 6, reference may be made to the implementation of the method in embodiment 6 for implementation of the apparatus, with identical contents being not going to be described herein any further.

FIG. 22 is a schematic diagram of the measurement apparatus of Embodiment 12 of this disclosure. As shown in FIG. 22, a measurement apparatus 2200 includes:

a processing unit 2201 configured not to perform measurement within a measurement gap or a part of time of a measurement gap when a time duration for performing reception or transmission of a low-latency service is overlapped with the measurement gap.

In this embodiment, reference may be made to Embodiment 6 for particular implementation of the processing unit 2201, which shall not be described herein any further.

It can be seen from the above embodiment that measurement is not performed within the measurement gap, that is, reception or transmission of the low latency service is performed. Hence, when a configured measurement gap occurs in the process of performing reception or transmission of a low-latency service, latency of the low-latency service may be reduced, and user experiences of low-latency service may be ensured.

### Embodiment 13

Embodiment 13 of this disclosure provides a terminal equipment. As a principle of the device for solving problems is similar to that of the method in Embodiment 6, reference may be made to the implementation of the method in Embodiment 6 for implementation of the device, with identical contents being not going to be described herein any further.

This embodiment further provides a terminal equipment (not shown), configured with the above-described measurement apparatus 2200.

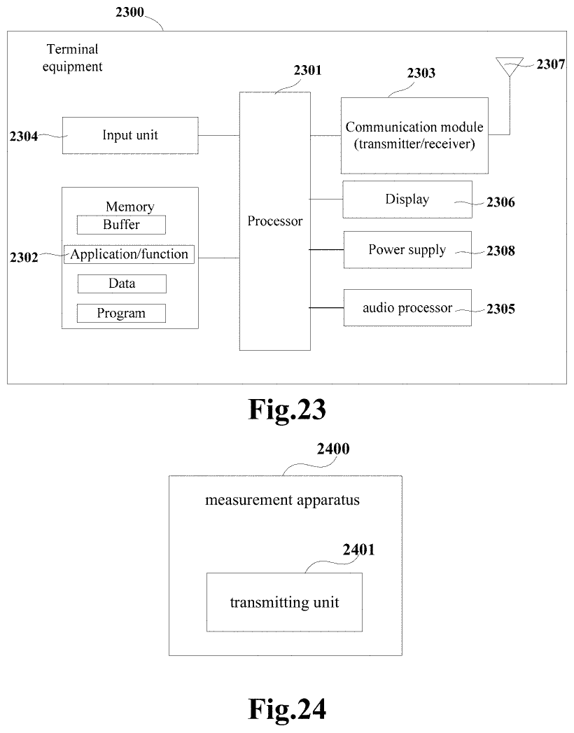

This embodiment further provides a terminal equipment. FIG. 23 is a schematic diagram of a structure of the terminal equipment of Embodiment 13 of this disclosure. As shown in FIG. 23, a terminal equipment 2300 may include a central processing unit (CPU) 2301 and a memory 2302, the memory 2302 being coupled to the central processing unit 2301. The memory 2302 may store various data, and furthermore, it may store a program for data processing, and execute the program under control of the central processing unit 2301, so as to perform measurement.

In one implementation, the functions of the measurement apparatus 2200 may be integrated into the central processing unit 2301, wherein the central processing unit 2301 may be configured to carry out the measurement method described in Embodiment 6.

For example, the central processing unit 2301 may be configured to: not perform measurement within a measurement gap or a part of time of a measurement gap when a time duration for performing reception or transmission of low-latency services is overlapped with the measurement gap.

Furthermore, reference may be made to Embodiment 6 for other configuration manners of the central processing unit 2301, which shall not be described herein any further.

In another implementation, the above apparatus 2200 and the central processing unit 2301 may be configured separately; for example, the apparatus 2200 may be configured as a chip connected to the central processing unit 2301, such as the unit shown in FIG. 23, and the functions of the apparatus 2200 are executed under control of the central processing unit 2301.

Furthermore, as shown in FIG. 23, the terminal equipment 2300 may include a communication module 2303, an input unit 2304, a display 2306, an audio processor 2305, an antenna 2307 and a power supply 2308, etc. Functions of the above components are similar to those in the related art, and shall not be described herein any further. It should be noted that the terminal equipment 2300 does not necessarily include all the parts shown in FIG. 23. Furthermore, the terminal equipment 2300 may include parts not shown in FIG. 23, and the related art may be referred to.

It can be seen from the above embodiment that measurement is not performed within the measurement gap, that is, reception or transmission of the low latency service is performed. Hence, when a configured measurement gap occurs in the process of performing reception or transmission of a low-latency service, latency of the low-latency service may be reduced, and user experiences of low-latency service may be ensured.

### Embodiment 14

Embodiment 14 of this disclosure provides a measurement apparatus. As a principle of the apparatus for solving problems is similar to that of the method in Embodiment 7, reference may be made to the implementation of the method in Embodiment 7 for implementation of the apparatus, with identical contents being not going to be described herein any further.

FIG. 24 is a schematic diagram of the measurement apparatus of Embodiment 14 of this disclosure. As shown in FIG. 24, a measurement apparatus 2400 includes:

a transmitting unit 2401 configured to transmit configuration information to a terminal equipment, the configuration information configuring that the terminal equipment does not perform measurement within a measurement gap or within a part of time of a measurement gap when a time duration for performing reception or transmission of a low-latency service by the terminal equipment is overlapped with the measurement gap or when a time duration for performing reception or transmission of a low-latency service by the terminal equipment is overlapped with the measurement gap and a predetermined condition related to a change of service quality is satisfied;

or the configuration information configuring that when the terminal equipment has a grant, the grant overrides a measurement gap in which no measurement is performed; or

transmit first indication information to the terminal equipment, the first indication information indicating information on a measurement gap in which no measurement is performed.

In this embodiment, reference may be made to Embodiment 7 for particular implementation of the processing unit 2401, which shall not be described herein any further.

It can be seen from the above embodiment that measurement is not performed within the measurement gap, that is, reception or transmission of the low latency service is performed. Hence, when a configured measurement gap occurs in the process of performing reception or transmission of a low-latency service, latency of the low-latency service may be reduced, and user experiences of low-latency service may be ensured.

### Embodiment 15

Embodiment 15 of this disclosure provides a network device. As a principle of the device for solving problems is similar to that of the method in Embodiment 7, reference may be made to the implementation of the method in Embodiment 7 for implementation of the device, with identical contents being not going to be described herein any further.

This embodiment further provides a network device (not shown), configured with the above-described measurement apparatus 2400.

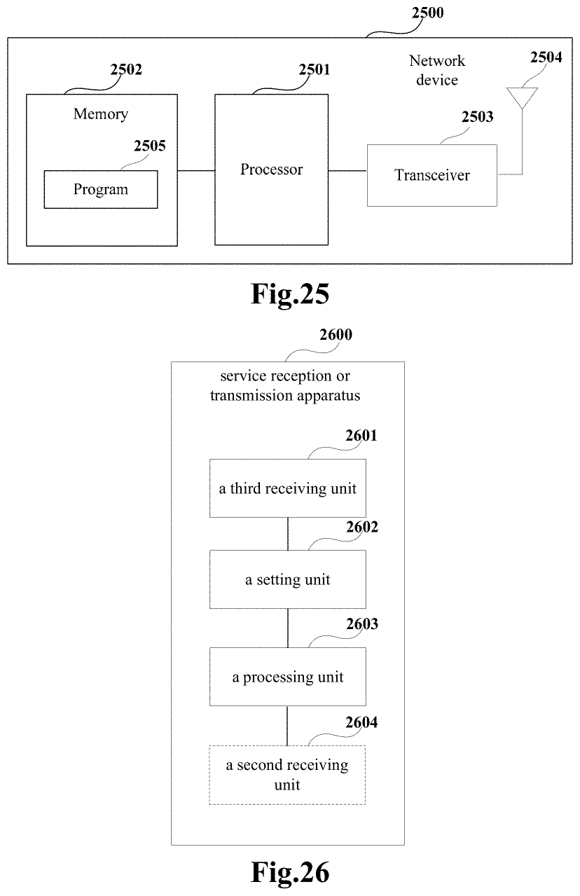

Embodiment 15 of this disclosure further provides a network device. As a principle of the device for solving problems is similar to that of the method in Embodiment 7, reference may be made to the implementation of the method in Embodiment 7 for implementation of the device, with identical contents being not going to be described herein any further. FIG. 25 is a schematic diagram of a structure of the network device. As shown in FIG. 25, a network device 2500 may include a central processing unit (CPU) 2501 and a memory 2502, the memory 2502 being coupled to the central processing unit 2501. The memory 2502 may store various data, and furthermore, it may store a program 2505 for data processing, and execute the program under control of the central processing unit 2501, so as to perform measurement.

In one implementation, the functions of the apparatus 2400 may be integrated into the central processing unit 2501, wherein the central processing unit 2501 may be configured to carry out the measurement method described in Embodiment 7.

For example, the central processing unit 2501 may be configured to: transmit configuration information to a terminal equipment, the configuration information configuring that the terminal equipment does not perform measurement within a measurement gap or within a part of time of a measurement gap when a time duration for performing reception or transmission of a low-latency service by the terminal equipment is overlapped with the measurement gap or when a time duration for performing reception or transmission of a low-latency service by the terminal equipment is overlapped with the measurement gap and a predetermined condition related to a change of service quality is satisfied;

or the configuration information configuring that when the terminal equipment has a grant, the grant overrides a measurement gap in which no measurement is performed;

or transmit first indication information to the terminal equipment, the first indication information indicating information on a measurement gap in which no measurement is performed.

Furthermore, reference may be made to Embodiment 7 for particular implementation of the processing unit 2501, which shall not be described herein any further.

In another implementation, the above apparatus 2400 and the central processing unit 2501 may be configured separately; for example, the apparatus 2400 may be configured as a chip connected to the central processing unit 2501, such as the unit shown in FIG. 25, and the functions of the apparatus 2400 are executed under control of the central processing unit 2501.

Furthermore, as shown in FIG. 25, the network device 2500 may include a transceiver 2503, and an antenna 2504, etc. Functions of the above components are similar to those in the related art, and shall not be described herein any further. It should be noted that the network device 2500 does not necessarily include all the parts shown in FIG. 25. Furthermore, the network device 2500 may include parts not shown in FIG. 25, and the related art may be referred to.

It can be seen from the above embodiment that measurement is not performed within the measurement gap, that is, reception or transmission of the low latency service is performed. Hence, when a configured measurement gap occurs in the process of performing reception or transmission of a low-latency service, latency of the low-latency service may be reduced, and user experiences of low-latency service may be ensured.

### Embodiment 16

Embodiment 16 provides a communication system, including a terminal equipment in Embodiment 9 and/or a network device in Embodiment 11, or including a terminal equipment in Embodiment 13 and/or a network device in Embodiment 15, the contents of which being incorporated herein, which shall not be described herein any further.

It can be seen from the above embodiment that reception or transmission of the low-latency service is performed within the measurement gap. Hence, when a configured measurement gap occurs in the process of performing reception or transmission of a low-latency service, latency of the low-latency service may be reduced, and user experiences of low-latency service may be ensured.

An embodiment of the present disclosure provides a computer readable program code, which, when executed in a service reception or transmission apparatus or a terminal equipment, will cause the service reception or transmission apparatus or the terminal equipment to carry out the service reception or transmission method as described in embodiments 1-4.

An embodiment of the present disclosure provides a computer storage medium, including a computer readable program code, which will cause a service reception or transmission apparatus or a terminal equipment to carry out the service reception or transmission method as described in embodiments 1-4.

An embodiment of the present disclosure provides a computer readable program code, which, when executed in a service reception or transmission apparatus or a network device, will cause the service reception or transmission apparatus or the network device to carry out the service reception or transmission method as described in Embodiment 5.

An embodiment of the present disclosure provides a computer storage medium, including a computer readable program code, which will cause a service reception or transmission apparatus or a network device to carry out the service reception or transmission method as described in Embodiment 5.

An embodiment of the present disclosure provides a computer readable program code, which, when executed in a measurement apparatus or a terminal equipment, will cause the measurement apparatus or the terminal equipment to carry out the measurement method as described in Embodiment 6.

An embodiment of the present disclosure provides a computer storage medium, including a computer readable program code, which will cause a measurement apparatus or a terminal equipment to carry out the measurement method as described in Embodiment 6.

An embodiment of the present disclosure provides a computer readable program code, which, when executed in a measurement apparatus or a network device, will cause the measurement apparatus or the network device to carry out the measurement method as described in Embodiment 7.

An embodiment of the present disclosure provides a computer storage medium, including a computer readable program code, which will cause a measurement apparatus or a network device to carry out the measurement method as described in Embodiment 7.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The service reception or transmission method or measurement method carried out in the service reception or transmission apparatus or measurement apparatus described with reference to the embodiments of this disclosure may be directly embodied as hardware, software modules executed by a processor, or a combination thereof. For example, one or more functional block diagrams and/or one or more combinations of the functional block diagrams shown in FIGS. 18-28 may either correspond to software modules of procedures of a computer program, or correspond to hardware modules. Such software modules may respectively correspond to the steps shown in FIGS. 2-11. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIGS. 18-28 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIGS. 12-16 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations containing the above embodiments, following supplements are further disclosed.

Supplement 1. A service reception or transmission method, including:

performing reception or transmission of a low-latency service by a terminal equipment within a measurement gap when a time duration for performing reception or transmission of the low-latency service is overlapped with the measurement gap.

Supplement 2. The method according to supplement 1, wherein the measurement gap is contained in a set predetermined time period, and the terminal equipment performs reception or transmission of the low-latency service within the predetermined time period.

Supplement 3. The method according to supplement 2, wherein the method further includes: setting the predetermined time period when a low-latency service is received or transmitted in advance.

Supplement 4. The method according to supplement 2, wherein the method further includes: performing measurement within a measurement gap after the predetermined time period when no low-latency service is received within the predetermined time period or no low-latency service is transmitted within the predetermined time period.

Supplement 5. The method according to supplement 2, wherein the predetermined time period is set by starting a timer.

Supplement 6. The method according to supplement 1, wherein the transmitting the low-latency service by terminal equipment within the measurement gap further includes:

transmitting information on the low-latency service by terminal equipment within the measurement gap.

Supplement 7. The method according to supplement 1, wherein method further includes:

receiving first indication information transmitted by a network device, the first indication information indicating information on the measurement gap for performing the reception or transmission of the low-latency service.

Supplement 8. The method according to supplement 7, wherein the first indication information is carried by a PDCCH, or MAC signaling, or RRC signaling.

Supplement 9. The method according to supplement 7, wherein the information on the measurement gap includes information on a number and/or a position of the measurement gap for performing the reception or transmission of the low-latency service.

Supplement 10. The method according to supplement 1, wherein before performing the reception or transmission of the low-latency service, the method further includes:

determining a predetermined condition related to a change of service quality is satisfied;

and when the predetermined condition related to a change of service quality is satisfied, performing the reception or transmission of the low-latency service by the terminal equipment within the measurement gap.

Supplement 11. The method according to supplement 10, wherein the predetermined condition includes that service quality of a serving cell is higher than a first threshold, or service quality of a serving cell is higher than a second threshold, and service quality of a neighboring cell is lower than a third threshold, or service quality of a neighboring cell is lower than a fourth threshold, or service quality of a serving cell is higher than service quality of a neighboring cell, or service quality of a serving cell is higher than service quality of a neighboring cell by a fifth threshold.

Supplement 12. The method according to supplement 10, wherein the method further includes:

receiving second indication information transmitted by the network device, the second indication information indicating the predetermined condition.

Supplement 13. The method according to supplement 1, wherein when the time duration for performing reception or transmission of the low-latency service being overlapped with the measurement gap includes there existing a low-latency service to be transmitted after measurement has been performed within the measurement gap, the method further includes:

turning back to a serving cell by the terminal equipment, proceeding with performing transmission of low-latency services within the measurement gap, and receiving acknowledgement of the low-latency service transmitted by the network device.

Supplement 14. The method according to supplement 1, wherein when the terminal equipment has a grant configured by the network device, the grant overrides the measurement gap for performing the reception or transmission of the low-latency service.

Supplement 15. The method according to supplement 1, wherein the method further includes:

receiving configuration information transmitted by the network device, the configuration information configuring that the terminal equipment performs reception or transmission of a low-latency service within a measurement gap when a time duration for performing the reception or transmission of the low-latency service by the terminal equipment is overlapped with the measurement gap, or when a time duration for performing the reception or transmission of the low-latency service by the terminal equipment is overlapped with the measurement gap and a predetermined condition related to a change of service quality is satisfied;

or the configuration information configuring that when a terminal equipment has a grant for a low-latency service, the grant overrides the measurement gap for performing the reception or transmission of the low-latency service.

Supplement 16. The method according to supplement 1, wherein in performing the reception or transmission of the low-latency service within the measurement gap, the terminal equipment does not perform measurement.

Supplement 17. A service reception or transmission method, including:

transmitting configuration information by a network device to a terminal equipment, the configuration information configuring that the terminal equipment performs reception or transmission of a low-latency service within a measurement gap when a time duration for performing the reception or transmission of the low-latency service by the terminal equipment is overlapped with the measurement gap, or when a time duration for performing the reception or transmission of the low-latency service by the terminal equipment is overlapped with the measurement gap and a predetermined condition related to a change of service quality is satisfied;

or the configuration information configuring that when the terminal equipment has a grant, the grant overrides a measurement gap for performing reception or transmission of a low-latency service;

or transmitting first indication information by a network device to a terminal equipment, the first indication information indicating information on a measurement gap for performing reception or transmission of a low-latency service.

Supplement 18. The method according to supplement 17, wherein the method further includes:

transmitting second indication information by the network device to the terminal equipment, the second indication information indicating the predetermined condition.

Supplement 19. The method according to supplement 17, wherein the method further includes:

performing the reception or transmission of the low-latency service within the measurement gap.

Supplement 20. A measurement method, including:

when a time duration for performing reception or transmission of a low-latency service is overlapped with a measurement gap, not performing measurement by a terminal equipment within the measurement gap or within a part of time of the measurement gap.

Supplement 21. A measurement method, including:

transmitting configuration information by a network device to a terminal equipment, the configuration information configuring that the terminal equipment does not perform measurement within a measurement gap or within a part of time of a measurement gap when a time duration for performing reception or transmission of a low-latency service by the terminal equipment is overlapped with the measurement gap, or when a time duration for performing reception or transmission of a low-latency service by the terminal equipment is overlapped with the measurement gap and a predetermined condition related to a change of service quality is satisfied;

or the configuration information configuring that when the terminal equipment has a grant, the grant overrides a measurement gap for not performing measurement;

or transmitting first indication information by a network device to a terminal equipment, the first indication information indicating information on a measurement gap for not performing measurement.

Supplement 22. A measurement apparatus, including:

a processing unit configured not to perform measurement within a measurement gap or within a part of time of a measurement gap when a time duration for performing reception or transmission of a low-latency service is overlapped with the measurement gap.

Supplement 23. A measurement apparatus, including:

a transmitting unit configured to transmit configuration information to a terminal equipment, the configuration information configuring that the terminal equipment does not perform measurement within a measurement gap or within a part of time of a measurement gap when a time duration for performing reception or transmission of a low-latency service by the terminal equipment is overlapped with the measurement gap, or when a time duration for performing reception or transmission of a low-latency service by the terminal equipment is overlapped with the measurement gap and a predetermined condition related to a change of service quality is satisfied;

or the configuration information configuring that when the terminal equipment has a grant, the grant overrides a measurement gap for not performing measurement;

or transmit first indication information to a terminal equipment, the first indication information indicating information on a measurement gap for not performing measurement.

What is claimed is:

1. A service reception or transmission apparatus, comprising:
a processing unit configured to perform reception or transmission of a low-latency service within a measurement gap when a time duration for performing reception or transmission of the low-latency service is overlapped with the measurement gap.

2. The apparatus according to claim 1, wherein the measurement gap is contained in a set predetermined time period, and the processing unit performs reception or transmission of the low-latency service within the predetermined time period.

3. The apparatus according to claim 2, wherein the apparatus further comprises:
a setting unit configured to set the predetermined time period when a low-latency service is received or transmitted in advance.

4. The apparatus according to claim 2, wherein the processing unit is further configured to perform measurement within a measurement gap after the predetermined time period when no low-latency service is received within the predetermined time period or no low-latency service is transmitted within the predetermined time period.

5. The apparatus according to claim 2, wherein the setting unit sets the predetermined time period by starting a timer.

6. The apparatus according to claim 1, wherein the processing unit transmits the low-latency service and/or information on the low-latency service within the measurement gap.

7. The apparatus according to claim 1, wherein the apparatus further comprises:
a first receiving unit configured to receive first indication information transmitted by a network device, the first indication information indicating information on the measurement gap for performing the reception or transmission of the low-latency service.

8. The apparatus according to claim 7, wherein the first indication information is carried by a downlink control channel or medium access control signaling or radio resource control signaling.

9. The apparatus according to claim 7, wherein the information on the measurement gap comprises information on a number and/or a position of the measurement gap for performing the reception or transmission of the low-latency service.

10. The apparatus according to claim 1, wherein the apparatus further comprises:
a determining unit configured to determine whether a predetermined condition related to a change of service quality is satisfied;
and when a determination result of the determining unit is that the predetermined condition related to a change of service quality is satisfied, the processing unit performs the reception or transmission of the low-latency service within the measurement gap.

11. The apparatus according to claim 10, wherein the predetermined condition comprises that service quality of a serving cell is higher than a first threshold, or service quality of a serving cell is higher than a second threshold, and service quality of a neighboring cell is lower than a third threshold, or service quality of a neighboring cell is lower than a fourth threshold, or service quality of a serving cell is higher than service quality of a neighboring cell, or service quality of a serving cell is higher than service quality of a neighboring cell by a fifth threshold.

12. The apparatus according to claim 10, wherein the apparatus further comprises:
a second receiving unit configured to receive second indication information transmitted by the network device, the second indication information indicating the predetermined condition.

13. The apparatus according to claim 1, wherein when the time duration for performing reception or transmission of the low-latency service being overlapped with the measurement gap comprises there existing a low-latency service to be transmitted after measurement has been performed within the measurement gap, the processing unit is further configured to turn back to a serving cell, proceed with performing transmission of low-latency services within the measurement gap, and receive acknowledgement of the low-latency service transmitted by the network device.

14. The apparatus according to claim 1, wherein when the terminal equipment has a grant configured by the network device, the grant overrides the measurement gap for performing the reception or transmission of the low-latency service.

15. The apparatus according to claim 1, wherein the apparatus further comprises:
a third receiving unit configured to receive configuration information transmitted by the network device, the configuration information configuring that the terminal equipment performs reception or transmission of a low-latency service within a measurement gap when a time duration for performing the reception or transmission of the low-latency service by the terminal equipment is overlapped with the measurement gap, or when a time duration for performing the reception or transmission of the low-latency service by the terminal equipment is overlapped with the measurement gap and a predetermined condition related to a change of service quality is satisfied;
or the configuration information configuring that when a terminal equipment has a grant for a low-latency service, the grant overrides the measurement gap for performing the reception or transmission of the low-latency service.

16. The apparatus according to claim 1, wherein in performing the reception or transmission of the low-latency service within the measurement gap, the processing unit does not perform measurement.

17. A service reception or transmission apparatus, comprising:
a first transmitting unit configured to transmit configuration information to a terminal equipment, the configuration information configuring that the terminal equipment performs reception or transmission of a low-latency service within a measurement gap when a time duration for performing the reception or transmission of the low-latency service by the terminal equipment is overlapped with the measurement gap, or when a time duration for performing the reception or transmission of the low-latency service by the terminal equipment is overlapped with the measurement gap and a predetermined condition related to a change of service quality is satisfied;
or the configuration information configuring that when the terminal equipment has a grant, the grant overrides a measurement gap for performing reception or transmission of a low-latency service;
or transmit first indication information to a terminal equipment, the first indication information indicating information on a measurement gap for performing reception or transmission of a low-latency service.

18. The apparatus according to claim 17, wherein the apparatus further comprises:
a second transmitting unit configured to transmit second indication information to the terminal equipment, the second indication information indicating the predetermined condition.

19. The apparatus according to claim 17, wherein the apparatus further comprises:
a transceiving unit configured to perform the reception or transmission of the low-latency service within the measurement gap.

20. A communication system, comprising a terminal equipment, the terminal equipment comprising the service reception or transmission apparatus as claimed in claim 1.
